(19) United States
(12) Patent Application Publication
(10) Pub. No.: US 2026/0032586 A1
(43) Pub. Date: Jan. 29, 2026

(54) CONFIGURATION OF A DISCONTINUOUS RECEPTION ACTIVE TIME TRIGGER ON A PER DOWNLINK BANDWIDTH PART BASIS

(71) Applicant: QUALCOMM Incorporated, San Diego, CA (US)

(72) Inventors: Kazuki TAKEDA, Minato-ku (JP); Changhwan PARK, San Diego, CA (US)

(21) Appl. No.: 18/784,026

(22) Filed: Jul. 25, 2024

(51) Int. Cl. H04W 52/02

(52) U.S. Cl. CPC H04W 52/0229

(57) ABSTRACT

Methods, systems, and devices for wireless communication are described. Various aspects relate generally to configurations of discontinuous reception (DRX) active time triggers on a per downlink bandwidth part (BWP) basis. Some aspects more specifically relate to a user equipment (UE) monitoring for downlink control information (DCI) format 2_6 or a low-power wake-up signal (LP-WUS) to trigger a DRX active time based on which downlink BWP is an active downlink BWP. For example, the UE may receive information pertaining to a set of downlink BWPs of a serving cell and the information may indicate a DRX active time trigger for each downlink BWP of the set of downlink BWPs. The UE may accordingly monitor for a specific type of DRX active time trigger based on the information and based on which of the set of downlink BWPs is the active downlink BWP.

### FIELD OF TECHNOLOGY

The following relates to wireless communication, including a configuration of a discontinuous reception (DRX) active time trigger on a per downlink bandwidth part (BWP) basis.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communication by a user equipment (UE) is described. The method may include receiving first information pertaining to a first set of multiple downlink bandwidth parts (BWPs) associated with a first serving cell, where the first information indicates that a first downlink BWP of the first set of multiple downlink BWPs is associated with monitoring for a downlink control information (DCI) message to trigger an active time associated with discontinuous reception (DRX) at the UE and that a second downlink BWP of the first set of multiple downlink BWPs is associated with monitoring for a wake-up signal to trigger the active time associated with the DRX at the UE and monitoring for the DCI message or the wake-up signal in accordance with the first information and in accordance with which of the first downlink BWP or the second downlink BWP is an active downlink BWP of the first serving cell.

A UE for wireless communication is described. The UE may include one or more memories storing processor executable code, and one or more processors coupled with the one or more memories. The one or more processors may individually or collectively be operable to execute the code to cause the UE to receive first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE and monitor for the DCI message or the wake-up signal in accordance with the first information and in accordance with which of the first downlink BWP or the second downlink BWP is an active downlink BWP of the first serving cell.

Another UE for wireless communication is described. The UE may include means for receiving first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE and means for monitoring for the DCI message or the wake-up signal in accordance with the first information and in accordance with which of the first downlink BWP or the second downlink BWP is an active downlink BWP of the first serving cell.

A non-transitory computer-readable medium storing code for wireless communication is described. The code may include instructions executable by one or more processors to receive first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE and monitor for the DCI message or the wake-up signal in accordance with the first information and in accordance with which of the first downlink BWP or the second downlink BWP is an active downlink BWP of the first serving cell.

In some examples of the method, UEs, and non-transitory computer-readable medium described herein, monitoring for the DCI message or the wake-up signal may include operations, features, means, or instructions for monitoring for the DCI message to trigger the active time in accordance with the first downlink BWP being the active downlink BWP of the first serving cell and monitoring for the wake-up signal to trigger the active time in accordance with the second downlink BWP being the active downlink BWP of the first serving cell.

In some examples of the method, UEs, and non-transitory computer-readable medium described herein, the first information indicates that the first downlink BWP may be configured with a search space set associated with the DCI message and that the second downlink BWP may be configured with one or more monitoring occasions associated with the wake-up signal.

In some examples of the method, UEs, and non-transitory computer-readable medium described herein, the first downlink BWP may be associated with monitoring for the DCI message to trigger the active time in accordance with being configured with the search space set associated with the DCI message and the second downlink BWP may be associated with monitoring for the wake-up signal to trigger the active time in accordance with being configured with the one or more monitoring occasions associated with the wake-up signal.

In some examples of the method, UEs, and non-transitory computer-readable medium described herein, the first information indicates that the first serving cell may be configured with one or more monitoring occasions associated with the wake-up signal; that the first downlink BWP may be configured with a search space set associated with the DCI message; and that the second downlink BWP may be absent of a search space set configuration associated with the DCI message.

A method for wireless communication by a network entity is described. The method may include transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE and transmitting the DCI message or the wake-up signal in accordance with the first information and in accordance with which of the first downlink BWP or the second downlink BWP is an active downlink BWP of the first serving cell.

A network entity for wireless communication is described. The network entity may include one or more memories storing processor executable code, and one or more processors coupled with the one or more memories. The one or more processors may individually or collectively be operable to execute the code to cause the network entity to transmit first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE and transmit the DCI message or the wake-up signal in accordance with the first information and in accordance with which of the first downlink BWP or the second downlink BWP is an active downlink BWP of the first serving cell.

Another network entity for wireless communication is described. The network entity may include means for transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE and means for transmitting the DCI message or the wake-up signal in accordance with the first information and in accordance with which of the first downlink BWP or the second downlink BWP is an active downlink BWP of the first serving cell.

A non-transitory computer-readable medium storing code for wireless communication is described. The code may include instructions executable by one or more processors to transmit first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE and transmit the DCI message or the wake-up signal in accordance with the first information and in accordance with which of the first downlink BWP or the second downlink BWP is an active downlink BWP of the first serving cell.

In some examples of the method, network entities, and non-transitory computer-readable medium described herein, transmitting the DCI message or the wake-up signal may include operations, features, means, or instructions for transmitting the DCI message to trigger the active time in accordance with the first downlink BWP being the active downlink BWP of the first serving cell and transmitting the wake-up signal to trigger the active time in accordance with the second downlink BWP being the active downlink BWP of the first serving cell.

In some examples of the method, network entities, and non-transitory computer-readable medium described herein, the first information indicates that the first downlink BWP may be configured with a search space set associated with the DCI message and that the second downlink BWP may be configured with one or more monitoring occasions associated with the wake-up signal.

In some examples of the method, network entities, and non-transitory computer-readable medium described herein, the first downlink BWP may be associated with transmission of the DCI message to trigger the active time in accordance with being configured with the search space set associated with the DCI message and the second downlink BWP may be associated with transmission of the wake-up signal to trigger the active time in accordance with being configured with the one or more monitoring occasions associated with the wake-up signal.

In some examples of the method, network entities, and non-transitory computer-readable medium described herein, the first information indicates that the first serving cell may be configured with one or more monitoring occasions associated with the wake-up signal; that the first downlink BWP may be configured with a search space set associated with the DCI message; and that the second downlink BWP may be absent of a search space set configuration associated with the DCI message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 shows an example of a wireless communications system that supports a configuration of a discontinuous reception (DRX) active time trigger on a per downlink bandwidth part (BWP) basis in accordance with one or more aspects of the present disclosure.

FIG. 2 shows an example signaling diagram that supports a configuration of a DRX active time trigger on a per downlink BWP basis in accordance with one or more aspects of the present disclosure.

FIG. 3 shows an example serving cell configuration that supports a configuration of a DRX active time trigger on a per downlink BWP basis in accordance with one or more aspects of the present disclosure.

FIGS. 4 and 5 show example communication timelines that support a configuration of a DRX active time trigger on a per downlink BWP basis in accordance with one or more aspects of the present disclosure.

FIG. 6 shows an example process flow that supports a configuration of a DRX active time trigger on a per downlink BWP basis in accordance with one or more aspects of the present disclosure.

FIGS. 7 and 8 show block diagrams of devices that support a configuration of a DRX active time trigger on a per downlink BWP basis in accordance with one or more aspects of the present disclosure.

FIG. 9 shows a block diagram of a communications manager that supports a configuration of a DRX active time trigger on a per downlink BWP basis in accordance with one or more aspects of the present disclosure.

FIG. 10 shows a diagram of a system including a device that supports a configuration of a DRX active time trigger on a per downlink BWP basis in accordance with one or more aspects of the present disclosure.

FIGS. 11 and 12 show block diagrams of devices that support a configuration of a DRX active time trigger on a per downlink BWP basis in accordance with one or more aspects of the present disclosure.

FIG. 13 shows a block diagram of a communications manager that supports a configuration of a DRX active time trigger on a per downlink BWP basis in accordance with one or more aspects of the present disclosure.

FIG. 14 shows a diagram of a system including a device that supports a configuration of a DRX active time trigger on a per downlink BWP basis in accordance with one or more aspects of the present disclosure.

FIGS. 15 and 16 show flowcharts illustrating methods that support a configuration of a DRX active time trigger on a per downlink BWP basis in accordance with one or more aspects of the present disclosure.

### DETAILED DESCRIPTION

In some wireless communications systems, a user equipment (UE) may employ one or more energy saving techniques to increase a battery life or otherwise reduce power consumption at the UE. An example of such an energy saving technique may be discontinuous reception (DRX). In accordance with DRX, a UE may enter a low power mode in which the UE refrains from monitoring for downlink signaling and intermittently (e.g., periodically or occasionally) activates one or more components to monitor for downlink signaling from a network entity. For example, the UE may enter an ON or active state to monitor a physical downlink control channel (PDCCH) within some time windows and may enter an OFF or inactive state (and not monitor the PDCCH) outside of such time windows. In such examples, DRX may be associated with a DRX cycle, with each cycle including at least one time window within which the UE may monitor a PDCCH. The time windows within which the UE may monitor a PDCCH may be understood or referred to as active times associated with DRX (e.g., “DRX active times”). In some cases, the UE may monitor for signaling outside of (e.g., in advance of) such active times to receive information indicating whether the UE is (or is likely to) receive PDCCH signaling within an upcoming active time. In such cases, the UE may selectively enter an ON or active state within the upcoming active time based on whether such advance signaling indicates (e.g., triggers) the UE to “wake up” for the upcoming active time.

Depending on the system, such advance signaling may include a downlink control information (DCI) message associated with a DCI format 2_6 or may include a wake-up signal, such as a low-power wake-up signal (LP-WUS). In other words, UEs in some systems may monitor for DCI format 2_6 to trigger an active time associated with DRX and UEs in some other systems may monitor for LP-WUSs to trigger an active time associated with DRX. Further, network entities of some systems may configure a UE with one of a search space set for DCI format 2_6 or monitoring occasions for LP-WUSs such that, for at least a given serving cell, a UE may expect to monitor for one of DCI format 2_6 or an LP-WUS to trigger a DRX active time. In some scenarios, however, such a restriction or expectation against a simultaneous configuration of DCI format 2_6 and LP-WUSs for triggering DRX active times for a given serving cell may limit system performance, as DCI format 2_6 and LP-WUSs may each be associated with unique characteristics that are more or less suitable for DRX operations depending on a deployment scenario, network condition, or UE capability/mode. For example, DCI format 2_6 may convey a secondary cell (SCell) dormancy indication and, accordingly, facilitate greater system knowledge along with providing a DRX active time trigger (at a potential cost of additional PDCCH monitoring). An LP-WUS may be a lower complexity DRX active time trigger and, accordingly, facilitate greater power savings or lower energy costs (at a potential cost of being unable to provide additional information, such as an SCell dormancy indication). Thus, some systems may benefit from additional configurational flexibility regarding use of different DRX active time triggers for a given serving cell.

Various aspects relate generally to configurations of DRX active time triggers on a per downlink bandwidth part (BWP) basis. Some aspects more specifically relate to one or more configuration- or signaling-based mechanisms according to which a UE may monitor for a DCI message associated with a DCI format 2_6 or an LP-WUS to trigger a DRX active time in accordance with (e.g., based on) which downlink BWP is an active downlink BWP. In some examples, a UE may receive information pertaining to (e.g., associated with) a set of downlink BWPs of a serving cell and the information may indicate, explicitly or implicitly, a DRX active time trigger for each downlink BWP of the set of downlink BWPs. For example, the information may indicate that a first downlink BWP of the set of downlink BWPs is associated with monitoring for a DCI format 2_6 to trigger a DRX active time and that a second downlink BWP of the set of downlink BWPs is associated with monitoring for an LP-WUS to trigger a DRX active time. In some implementations, the information may indicate that the first downlink BWP is configured with a search space set associated with DCI format 2_6 and that the second downlink BWP is configured with one or more monitoring occasions associated with LP-WUSs. Additionally, or alternatively, the information may indicate that the first downlink BWP is configured with a search space set associated with DCI format 2_6, that the second downlink BWP is absent of a search space set configuration associated with DCI format 2_6, and that the serving cell is configured with one or more monitoring occasions associated with LP-WUSs. A network entity may transmit the information via radio resource control (RRC) signaling, one or more medium access control (MAC) control elements (MAC-CEs), one or more DCI messages, or any combination thereof.

The UE, in accordance with receiving the information, may monitor for DCI format 2_6 or an LP-WUS as a DRX active time trigger based on which of the first downlink BWP or the second downlink BWP is the active downlink BWP of the serving cell. For example, if the first downlink BWP is the active downlink BWP of the serving cell, the UE may monitor for DCI format 2_6 as the DRX active time trigger. Alternatively, if the second downlink BWP is the active downlink BWP of the serving cell, the UE may monitor for an LP-WUS as the DRX active time trigger. Accordingly, the network entity and the UE may (dynamically or periodically) switch between using DCI format 2_6 and an LP-WUS as the DRX active time trigger in accordance with (dynamically or periodically) switching the active downlink BWP of the serving cell. Some aspects further relate to one or more rules, configurations, or expectations associated with simultaneously using different DRX active timer triggers, or different serving cell configuration structures, across different serving cells supported by the UE, among other aspects.

Particular aspects of the subject matter of the present disclosure may be implemented to realize one or more of the following advantages. In some examples, by configuring or activating different downlink BWPs of a same serving cell with different DRX active timer triggers, a network entity and a UE may opportunistically or selectively switch between using DCI format 2_6 and LP-WUSs as the DRX active time trigger in accordance with a current deployment scenario, network condition, or UE capability/mode. For example, if PDCCH reception quality fails to satisfy a threshold quality or if the UE enters a relatively lower power mode (e.g., a mode in which the UE turns off a main radio and relies on an auxiliary radio, among other examples), the network entity and the UE may switch the active downlink BWP to be a downlink BWP associated with monitoring for an LP-WUS to trigger the DRX active time, which may enable the UE to increase power savings and extend a battery life. Alternatively, if PDCCH reception quality satisfies a threshold quality or if the UE enters a relatively higher power mode (e.g., a mode in which the UE operates a main radio), the network entity and the UE may switch the active downlink BWP to be a downlink BWP associated with monitoring for DCI format 2_6 to trigger the DRX active time, which may enable the UE to obtain additional system knowledge (e.g., an SCell dormancy indication).

Further, by supporting one or more rules, configurations, or expectations associated with simultaneous usage of different DRX active timer triggers, or different serving cell configuration structures, across different serving cells supported by the UE, the network entity and the UE may maintain synchronized expectations as to which of a DCI format 2_6 or an LP-WUS may be used to trigger a DRX active time. Such rules, configurations, or expectations may also enable the network entity and the UE to operate in accordance with (e.g., in a manner adapted to) a UE capability/mode. For example, by allowing the UE to expect DCI format 2_6 to trigger a DRX active time on a first serving cell and to expect an LP-WUS to trigger a DRX active time on a second serving cell, the network entity may leverage relatively greater UE capability or processing power to provide greater system flexibility. Alternatively, by restricting the UE to expect one of DCI format 2_6 or an LP-WUS to trigger a DRX active time across both the first serving cell and the second serving cell (e.g., multiple serving cells), the network entity may leverage system coordination to reduce a processing burden at the UE. Accordingly, the described techniques may be implemented to realize greater power savings, longer battery lifetimes, and adaptive mechanisms to suitably accommodate various UE capabilities, modes, or processing loads, among other benefits.

Aspects of the disclosure are initially described in the context of wireless communications systems. Additionally, aspects of the disclosure are further illustrated by and described with reference to a signaling diagram, a serving cell configuration, communication timelines, and a process flow. Aspects of the disclosure are further illustrated by and described with reference to apparatus diagrams, system diagrams, and flowcharts that relate to configuration of a discontinuous reception active time trigger on a per downlink bandwidth part basis.

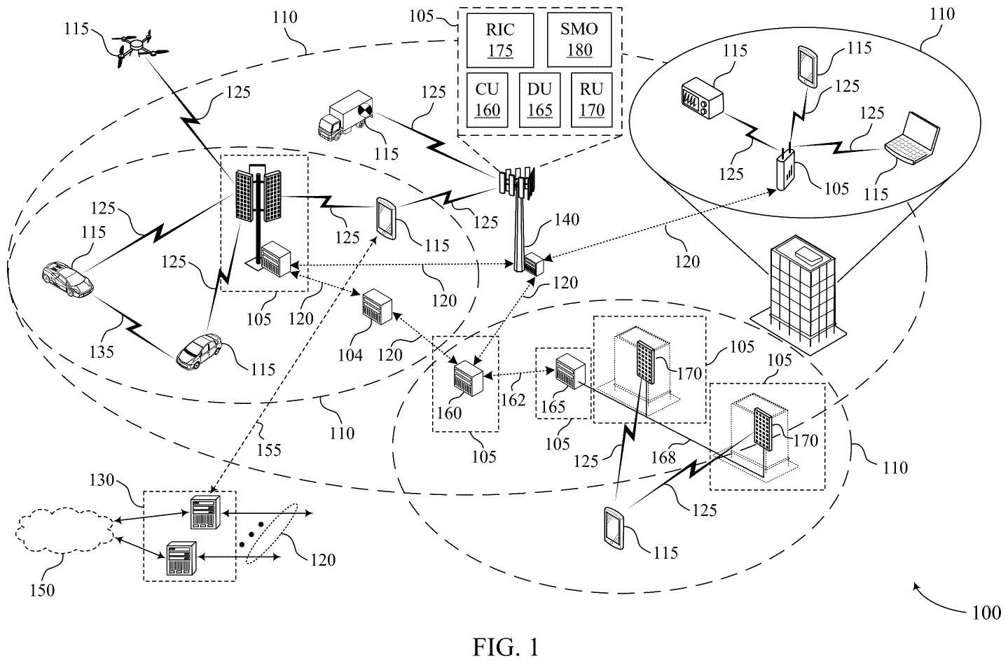

FIG. 1 shows an example of a wireless communications system 100 that supports a configuration of a discontinuous reception active time trigger on a per downlink bandwidth part basis in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, MAC layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support test as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers. In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

Some UEs 115, such as MTC or IoT devices, may be relatively low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that uses the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

In some wireless communications systems, such as the wireless communications system 100, one or more wireless communication devices may support, leverage, employ, or otherwise communicate in accordance with DRX as defined by, for example, a DRX configuration. A DRX configuration may define or be otherwise associated with a DRX ON duration, a DRX cycle length, and a DRX inactivity timer, among other examples. A network entity 105 may transmit information indicative of a DRX configuration to a UE 115 via, for example RRC signaling (e.g., via one or more RRC information elements, parameters, or fields). As described herein, a network entity 105 may transmit information indicative of one or more higher layer parameters via RRC signaling and a UE 115 may receive (and be configured by) such higher layer parameters. In some cases, DRX (e.g., a DRX configuration) may be associated with or include a DRX active time, which may refer to a time window within which a UE 115 monitors a PDCCH for downlink signaling or traffic from a network entity 105.

Outside of when a DRX active time is configured or scheduled to occur, such as in advance of when a DRX active time is configured or scheduled to occur, a UE 115 may monitor for signaling indicating whether the UE 115 is to enter an ON or active state (e.g., is to “wake up”) within the upcoming DRX active time or is able to remain in an OFF or inactive state (e.g., is able to remain “asleep”) within the upcoming DRX active time. In some systems, such signaling may include a DCI message associated with a specific DCI format, such as a DCI format 2_6. In other words, DCI format 2_6 may be used for notifying power saving information outside of DRX active time (for one or multiple UEs 115).

DCI format 2_6 may be scrambled by a power saving (PS) radio network temporary identifier (RNTI) (PS-RNTI). In some systems, DCI format 2_6 with a CRC scrambled by a PS-RNTI may be referred to as a “DCP.” In some cases, a DCP may be configured (by a network entity 105) per cell group (via PhysicalCellGroupConfig) and monitoring a PDCCH for DCI format 2_6 may be limited to being on a primary cell (PCell), a primary secondary cell (PSCell), or a special cell (SpCell). RRC parameters for the PDCCH for DCI format 2_6 may be provided as for other PDCCH resources, such as via RRC information elements controlResourceSet and searchSpace. The search space set for DCI format 2_6 may be defined as a Type-3 common search space (CSS) set.

DCI format 2_6 may include information conveyed by one or more blocks within the DCI. For example, DCI format 2_6 may include a block number 1, a block number 2, and so on up to a block number N, with N being any number. In some cases, a starting position of a block may be determined by a parameter ps-PositionDCI-2-6, which may be provided or signaled by higher layers for a UE 115 configured with the block. For example, a UE 115 configured by ps-PositionDCI-2-6 that indicates block number 2 may parse a DCI message associated with DCI format 2_6 to extract information from the block number 2 within the DCI message. In other words, if the UE 115 is configured with a higher layer parameter ps-RNTI and dci-Format2-6, one block may be configured for the UE 115 by higher layers. In yet other words, a UE 115 may be configured to monitor DCI format 2_6 that is with CRC scrambled by PS-RNTI for a block of bits in the DCI format. Thus, a location of a block of bits intended for, addressed to, or associated with a UE 115 may be configured by UE-specific RRC signaling.

Each block within DCI format 2_6 may include one or more fields or bits. For example, a block within DCI format 2_6 may include at least a first field or bit including a wake-up indication (which may be a 1-bit indicator) and may optionally include a second field including an SCell dormancy indication. The SCell dormancy indication may be 0 bits if a higher layer parameter dormancyGroupOutsideActiveTime is not configured. Otherwise, the SCell dormancy indication may be a 1-, 2-, 3-, 4-, or 5-bit bitmap. A size of the bitmap may be associated with (e.g., determined or indicated by) a quantity of different DormancyGroupID(s) provided by a higher layer parameter dormancyGroupOutsideActiveTime, with each bit corresponding to one of the SCell group(s) configured by the higher layer parameter dormancyGroupOutsideActiveTime. In some cases, a most significant bit (MSB) to a least significant bit (LSB) of the bitmap may correspond to a first configured SCell group to a last configured SCell group in ascending order of DormancyGroupID.

In some cases, a network entity 105 may provide a UE 115 configured with DRX mode operation with information associated with a detection of a DCI format 2_6 in a PDCCH reception on a serving cell, such as on a PCell, a PSCell, or an SpCell. Such information may include a PS-RNTI for DCI format 2_6, which a network entity 105 may indicate to a UE 115 via a ps-RNTI parameter. Additionally, such information may include a quantity of search space sets, indicated by dci-Format2-6, to monitor for a detection of DCI format 2_6 on an active downlink BWP of the PCell, the PSCell, or the SpCell (according to a common search space monitoring operation). Additionally, such information may include a payload size for DCI format 2_6 (e.g., a total payload size of the DCI format 2_6), which a network entity 105 may indicate to a UE 115 via a sizeDCI-2-6 parameter (e.g., an RRC parameter, such as a UE-specific RRC parameter). Additionally, such information may include a location in DCI format 2_6 of a wake-up indication bit, which a network entity 105 may indicate to a UE 115 via a ps-PositionDCI-2-6 parameter. Additionally, in examples in which a UE 115 is provided with a quantity of groups of configured SCells by dormancyGroupOutsideActiveTime, such information may include a bitmap.

In some cases, a ‘0’ value for the wake-up indication bit, when reported to higher layers, may indicate a UE 115 to not start a drx-onDurationTimer for a next DRX cycle (e.g., a next long DRX cycle). Alternatively, a ‘1’ value for the wake-up indication bit, when reported to higher layers, may indicate a UE 115 to start the drx-onDurationTimer for the next DRX cycle (e.g., the next long DRX cycle). In some cases, a location of the bitmap with DCI format 2_6 may be after (e.g., immediately after) the wake-up indication bit location. The bitmap size may be equal to a quantity of groups of configured SCells where each bit of the bitmap corresponds to a group of configured SCells from the quantity of groups of configured SCells.

A value of ‘0’ for a bit of the bitmap may indicate an active downlink BWP, provided by dormantBWP-Id, for a UE 115 for each activated SCell in the corresponding group of configured SCells. A value of ‘1’ for a bit of the bitmap indicates an active downlink BWP, provided by firstOutsideActiveTimeBWP-Id, for a UE 115 for each activated SCell in the corresponding group of configured SCells if a current active downlink BWP is a dormant downlink BWP and/or a current active downlink BWP, for the UE 115 for each activated SCell in the corresponding group of configured SCells if the current active downlink BWP is not the dormant downlink BWP. In some cases, a UE 115 may set an active downlink BWP to the indicated active downlink BWP (as indicated by the bitmap). In other words, the bitmap may indicate SCell dormancy information for up to five SCell groups to switch to/from dormant BWP, where the SCell grouping is configured (e.g., indicated) by RRC signaling.

In examples in which a UE 115 is provided (e.g., configured with) search space sets to monitor PDCCH for detection of DCI format 2_6 in an active downlink BWP of the PCell, the PSCell, or of the SpCell and the UE 115 detects DCI format 2_6, a physical layer of the UE 115 may report a value of the wake-up indication bit for the UE 115 to higher layers for a next long DRX cycle. Alternatively, in examples in which a UE 115 is provided (e.g., configured with) search space sets to monitor PDCCH for detection of DCI format 2_6 in an active downlink BWP of the PCell, the PSCell, or of the SpCell and the UE 115 does not detect DCI format 2_6, the UE 115 may not report a value of the wake-up indication bit to higher layers for the next long DRX cycle. In examples in which a UE 115 is provided search space sets to monitor PDCCH for detection of DCI format 2_6 in the active downlink BWP of the PCell, the PSCell, or of the SpCell and the UE 115 is not required to monitor PDCCH for detection of DCI format 2_6 for a set of corresponding PDCCH monitoring occasions outside of active time prior to a next long DRX cycle or does not have any PDCCH monitoring occasions for detection of DCI format 2_6 outside of active time of a next long DRX cycle, a physical layer of the UE 115 may report a value of ‘1’ for the wake-up indication bit to higher layers for the next long DRX cycle.

Further, if a long DRX cycle is used for a DRX group and the drx-NonIntegerLongCycleStartOffset is configured, and floor([(DRX_SFN_COUNTER×10240)+(SFN×10)+subframe number] modulo (drx-NonIntegerLongCycle))=floor([(drx-TimeReferenceSFN×10)+drx-StartOffset] modulo (drx-NonIntegerLongCycle)), and if DCP monitoring is configured for the active downlink BWP, and if at least one of a set of conditions is satisfied, a device (e.g., a UE 115) may start drx-onDurationTimer after drx-SlotOffset from a beginning of a subframe. The set of conditions may include: if DCP indication associated with the current DRX cycle received from lower layer indicated to start drx-onDurationTimer; or if a set of DCP occasion(s) in time domain associated with a current DRX cycle occurred in active time considering grants/assignments/DRX command MAC-CE/long DRX command MAC-CE received and scheduling request sent until 4 milliseconds (ms) prior to a start of the last DCP occasion, or during a measurement gap, or when the MAC entity monitors for a PDCCH transmission on the search space indicated by recoverySearchSpaceId of the SpCell identified by the cell-specific RNTI (C-RNTI) while the ra-ResponseWindow is running; or if ps-Wakeup is configured with a value of true and DCP indication associated with the current DRX cycle has not been received from lower layers. Otherwise, if at least one of those conditions is not satisfied, a device (e.g., a UE 115) may start drx-onDurationTimer for this DRX group after drx-SlotOffset from the beginning of the subframe.

In some systems, signaling to trigger a DRX active time may include an LP-WUS. For example, PDCCH monitoring may be triggered by an LP-WUS with a connected mode DRX (C-DRX) configuration. In such systems, wake-up signaling may include the LP-WUS and may exclude a DCI message associated with a DCI format 2_6. Thus, various wireless communication devices (e.g., one or more network entities 105 or one or more UEs 115) may assume or expect that DCP monitoring and LP-WUS monitoring are not configured simultaneously for a UE 115. For example, LP-WUS procedures to trigger PDCCH monitoring within a DRX active time may replace DCI format 2_6 monitoring. In other words, LP-WUS monitoring according to an LP-WUS monitoring configuration before drx-onDurationTimer to trigger the starting of the drx-onDurationTimer may replace DCP functionality.

Accordingly, with a C-DRX configuration, a UE 115 may monitor for an LP-WUS in one or more LP-WUS monitoring occasions/windows for a DRX ON time in each DRX cycle, at least a time gap (e.g., a minimum gap) before a slot at which the drx-onDurationTimer would start. The LP-WUS may indicate to the UE 115 whether the UE 115 is to monitor PDCCH in the DRX active time of the DRX cycle. In some cases, a UE 115 may be configured (by a network entity 105) with PDCCH skipping or search space set group (SSSG) switching such that PDCCH monitoring in the DRX active time, even if triggered by an LP-WUS, may be skipped/reduced by a PDCCH skipping or SSSG switching indication, which may increase power savings (especially if the value(s) of drx-onDurationTimer and/or drx-InactivityTimer is/are relatively large).

In some systems, however, using LP-WUS monitoring as an exclusive alternative to DCI format 2_6 monitoring to trigger a DRX active time may adversely impact performance within a wireless communications system. For example, by enforcing rules according to which a UE 115 is not simultaneously configured with DCI format 2_6 and LP-WUS monitoring to trigger a DRX active time, systems may lack flexibility that may otherwise enable the system to adapt to one or more of various operating deployments, conditions, capabilities, or modes. For instance, if use of LP-WUSs to trigger an active time associated with a DRX configuration or cycle disallows use of an SCell dormancy indication (which is included within DCI format 2_6), a network entity 105 may be unable to provide an SCell dormancy indication (even though an SCell dormancy indication may still be useful for a UE 115 configured with LP-WUS monitoring occasions). Enabling simultaneous use of both DCI format 2_6 and LP-WUS monitoring to trigger a DRX active time for a given serving cell, however, may result in additional complexity (and power consumption) at a UE 115, which may also adversely impact system performance. Thus, some systems may benefit from additional configurational aspects and flexibility associated with simultaneous configuration of DCI format 2_6 and LP-WUS monitoring without (the expectation of) simultaneous use of DCI format 2_6 and LP-WUS monitoring for a given serving cell.

Accordingly, in some implementations of the present disclosure, various wireless communication devices (e.g., one or more network entities 105 or one or more UEs 115, or any combination thereof) may support one or more configuration- or signaling-based mechanisms according to which a UE 115 may be simultaneously configured with both DCI format 2_6 and LP-WUS monitoring and may perform one of DCI format 2_6 or LP-WUS monitoring at a given time for a given serving cell. In some examples, to facilitate such a configuration and use of DCI format 2_6 and LP-WUS monitoring, a network entity 105 may transmit information to a UE 115 indicating configurations of DCI format 2_6 monitoring or LP-WUS monitoring, or both, on a per downlink BWP basis. Such information may explicitly or implicitly indicate that, for example, a first downlink BWP is associated with monitoring for DCI format 2_6 to trigger a DRX active time (e.g., a use of DCI format 2_6 as the trigger of DRX active time) and a second downlink BWP is associated with monitoring for an LP-WUS to trigger a DRX active time (e.g., a use of an LP-WUS as the trigger of DRX active time). In such examples, the UE 115 may use or expect to monitor for a DCI format 2_6 to trigger the DRX active time in examples in which (e.g., when) the first downlink BWP is the active downlink BWP and to monitor for an LP-WUS to trigger the DRX active time in examples in which (e.g., when) the second downlink BWP is the active downlink BWP.

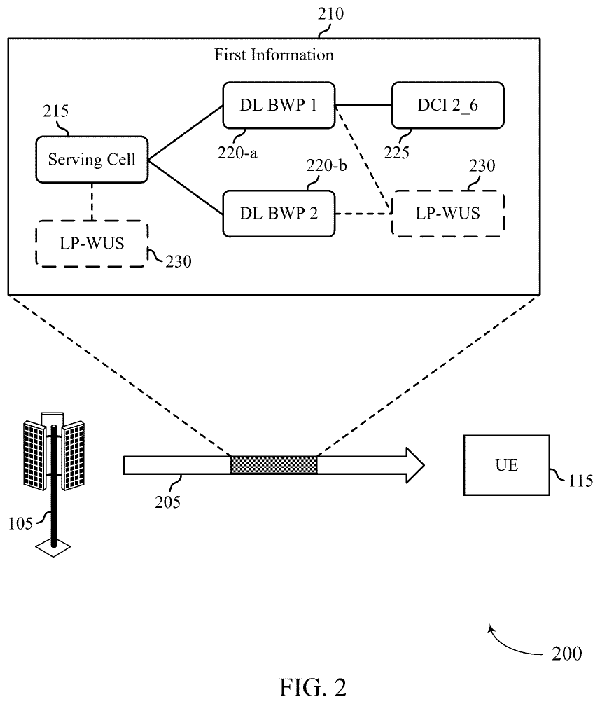

FIG. 2 shows an example signaling diagram 200 that supports a configuration of a DRX active time trigger on a per downlink BWP basis in accordance with one or more aspects of the present disclosure. The signaling diagram 200 may implement or be implemented to realize one or more aspects of the wireless communications system 100. For example, the signaling diagram 200 illustrates communication between a network entity 105 and a UE 115, which may be examples of corresponding devices as illustrated by and described with reference to FIG. 1. In some aspects, the network entity 105 and the UE 115 may support one or more mechanisms according to which the network entity 105 and the UE 115 may (dynamically, periodically, occasionally, or semi-persistently) switch between using DCI messages associated with a DCI format 2_6 or LP-WUSs to trigger a DRX active time at the UE 115 in accordance with per-BWP (e.g., BWP specific) configurations related to DCI format 2_6 monitoring or LP-WUS monitoring.

In some implementations, for example, the network entity 105 may transmit, to the UE 115 via a communication link 205, first information 210 pertaining to downlink BWPs associated with a serving cell 215 (e.g., a PCell, a PSCell, or an SpCell). In some examples, the downlink BWPs associated with the serving cell 215 may include a downlink BWP 220-a (illustrated in the example of the signaling diagram 200 as “DL BWP 1”) and a downlink BWP 220-b (illustrated in the example of the signaling diagram 200 as “DL BWP 2”). The first information 210 may indicate that the downlink BWP 220-a is associated with monitoring for a DCI message 225 (e.g., DCI format 2_6, which may also be referred to as “DCI 2_6”) to trigger the DRX active time and that the downlink BWP 220-b is associated with monitoring for an LP-WUS 230 to trigger the DRX active time.

In some examples, the network entity 105 may transmit the first information 210 via control signaling, such as via RRC signaling, and the first information 210 may indicate that the downlink BWP 220-a is configured with a search space set associated with the DCI message 225 (e.g., the DCI format 2_6) and that the downlink BWP 220-b is configured with monitoring occasions associated with the LP-WUS 230. In other words, the network entity 105 may (selectively) configure a search space set for DCI format 2_6 per downlink BWP of the serving cell 215 and may (selectively) configure an LP-WUS RRC configuration per downlink BWP of the serving cell 215. In such examples, when the downlink BWP 220-a is active, the UE 115 may monitor the search space set associated with the DCI message 225 and the DCI message 225, if received, may trigger the UE 115 to start a drx-onDurationTimer. Alternatively, when the downlink BWP 220-b is active, the UE 115 may monitor for the LP-WUS 230 and one or more designated bits, sequences, or patterns of the LP-WUS 230 may trigger the UE 115 to start a drx-onDurationTimer. In some aspects, the network entity 105 may configure (e.g., indicate or provide) such one or more designated bits, sequences, or patterns of the LP-WUS 230 that trigger the UE 115 to start a drx-onDurationTimer via RRC signaling. For example, the network entity 105 may pre-configure such one or more designated bits, sequences, or patterns of the LP-WUS 230 that trigger the UE 115 to start a drx-onDurationTimer by RRC signaling.

Additionally, or alternatively, the network entity 105 may transmit the first information 210 via control signaling, such as via RRC signaling, and the first information 210 may indicate that the downlink BWP 220-a is configured with a search space set associated with the DCI message 225 (e.g., the DCI format 2_6) and that the serving cell 215 is configured with monitoring occasions associated with the LP-WUS 230. In other words, the network entity 105 may (selectively) configure a search space set for DCI format 2_6 per downlink BWP of the serving cell 215 and may (selectively) configure an LP-WUS RRC configuration per serving cell (such that an LP-WUS RRC configuration is configured on one or more of the PCell, the SpCell, or the PSCell). In such examples, when the downlink BWP 220-a is active (e.g., a downlink BWP that has a configuration of DCI format 2_6), the UE 115 may monitor the search space set associated with the DCI message 225 and the DCI message 225, if received, may trigger the UE 115 to start a drx-onDurationTimer. Alternatively, when the downlink BWP 220-b is active (e.g., a downlink BWP that does not have a configuration of DCI format 2_6), the UE 115 may monitor for the LP-WUS 230 and one or more designated bits, sequences, or patterns of the LP-WUS 230 may trigger the UE 115 to start a drx-onDurationTimer. In examples in which the downlink BWP 220-b is active and the LP-WUS RRC configuration is provided at the serving cell level, the network entity 105 and the UE 115 may configure or expect a frequency domain location of the associated LP-WUSs to be within the downlink BWP 220-b or to be within a frequency range via which a dedicated radio (e.g., a radio dedicated to receiving LP-WUSs, such as an auxiliary radio of the UE 115) is able to receive signaling, or both.

Additionally, or alternatively, the network entity 105 may transmit the first information 210 via multiple types of signaling. For example, a first type of signaling may indicate that the downlink BWP 220-a is associated with monitoring for both the DCI message 225 and the LP-WUS 230 and a second type of signaling may further indicate that, of monitoring for the DCI message 225 and the LP-WUS 230, the downlink BWP 220-a is to be associated with monitoring for one of the DCI message 225 or the LP-WUS 230. For example, the network entity 105 may configure the downlink BWP 220-a with a search space set for DCI format 2_6 monitoring and with one or more LP-WUS monitoring occasions and may (subsequently) indicate that one of the search space set for DCI format 2_6 monitoring or the LP-WUS monitoring occasions are to be used to trigger DRX active time. In some examples, the second signaling may indicate that, of monitoring for the DCI message 225 and the LP-WUS 230, the downlink BWP 220-a is to be associated with monitoring for one of the DCI message 225. In some aspects, the first type of signaling may include RRC signaling and the second type of signaling may include additional RRC signaling, one or more MAC-CEs, one or more DCI messages, or any combination thereof.

The network entity 105 may activate one of the downlink BWP 220-a and the downlink BWP 220-b as an active downlink BWP for the serving cell 215. In some examples, the network entity 105 may activate one of the downlink BWP 220-a and the downlink BWP 220-b as an active downlink BWP for the serving cell 215 via dynamic signaling (e.g., one or more MAC-CEs, one or more DCI messages, or any combination thereof). Additionally, or alternatively, the network entity 105 may activate one of the downlink BWP 220-a and the downlink BWP 220-b as an active downlink BWP for the serving cell 215 via signaling (e.g., RRC signaling, one or more MAC-CEs, or one or more DCI messages) that configures a pattern of active downlink BWPs for the serving cell 215. Such a pattern of active downlink BWPs may indicate timing information associated with which downlink BWP is the active downlink BWP at a specific time, within a specific time window, or for a specific timer duration, among other examples.

Accordingly, the UE 115 may switch between the downlink BWP 220-a being the active downlink BWP and the downlink BWP 220-b being the active downlink BWP (with one of the downlink BWP 220-a or the downlink BWP 220-b being the active downlink BWP for the serving cell 215 at a given time). In accordance with such aspects, the network entity 105 and the UE 115 may use either the DCI message 225 or the LP-WUS 230 to trigger a DRX active time (e.g., as defined at least in part by a starting of a drx-onDurationTimer) depending on which of the downlink BWP 220-a or the downlink BWP 220-b is active. Thus, the UE 115 may switch between monitoring for the DCI message 225 to trigger the DRX active time and monitoring for the LP-WUS 230 to trigger the DRX active time depending on signaling or one or more timers. Such a dynamic (and low latency) or periodic switching may provide the network entity 105 and the UE 115 flexibility to use the DCI message 225 or the LP-WUS 230 to trigger the DRX active time depending on a current deployment scenario, operating condition, capability, or mode, among other factors that one or both of the network entity 105 or the UE 115 may consider as part of determining whether to use the DCI message 225 or the LP-WUS 230 to trigger the DRX active time.

Further, although some aspects are illustrated and described in examples in which possible DRX active time triggers include DCI format 2_6 and LP-WUSs, the possible DRX active time triggers may additionally, or alternatively, include any other types of signaling. Thus, more generally, the first information 210 may indicate that the downlink BWP 220-a is associated with a first type of signaling to trigger a DRX active time and that the downlink BWP 220-b is associated with a second type of signaling to trigger a DRX active time, with such first and second types of signaling be any types of signaling usable by the network entity 105 or the UE 115 to trigger a DRX active time. Further, the UE 115 may transmit capability information pertaining to which implementations the UE 115 supports including, for example, which types of signaling the UE 115 supports to trigger a DRX active time.

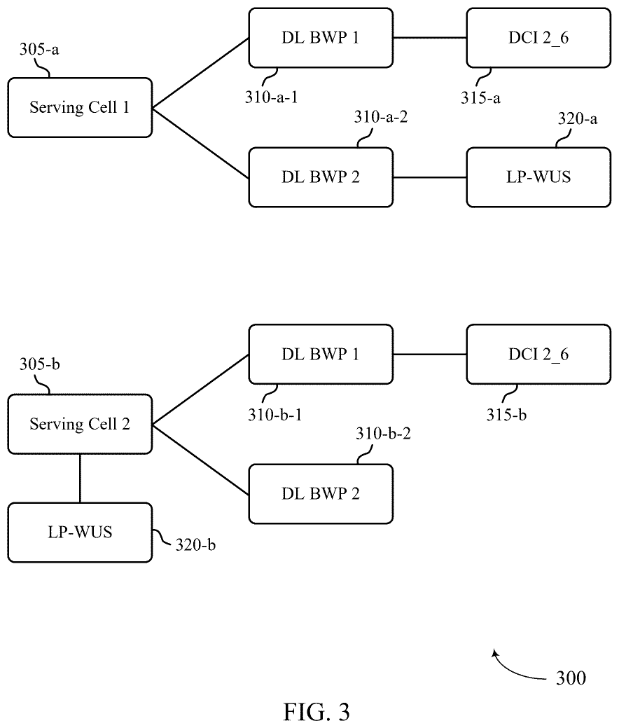

FIG. 3 shows an example serving cell configuration 300 that supports a configuration of a DRX active time trigger on a per downlink BWP basis in accordance with one or more aspects of the present disclosure. The serving cell configuration 300 may implement or be implemented to realize one or more aspects of the wireless communications system 100 or the signaling diagram 200. For example, a network entity 105 may transmit information indicative of or otherwise pertaining to the serving cell configuration 300 to a UE 115, with such a network entity 105 and a UE 115 being examples of corresponding devices as illustrated and described herein, including by and with reference to FIGS. 1 and 2.

In accordance with the serving cell configuration 300, the network entity 105 may configure the UE 115 with a serving cell 305-a and a serving cell 305-b, which may be two different serving cells. In some examples, the serving cell 305-a and the serving cell 305-b may be associated with different groups of cells, such as different cell groups, different PUCCH groups, or different DRX groups. For example, the serving cell 305-a may be associated with a master cell group (MCG) and the serving cell 305-b may be associated with a secondary cell group (SCG). Additionally, or alternatively, the serving cell 305-a may be associated with a primary PUCCH group and the serving cell 305-b may be associated with a secondary PUCCH group. Additionally, or alternatively, the serving cell 305-a may be associated with a first DRX group and the serving cell 305-b may be associated with a second DRX group. The serving cell 305-a and the serving cell 305-b may be associated with a same DRX configuration or may be associated with different DRX configurations.

The serving cell 305-a may be associated with a downlink BWP 310-a-1 and a downlink BWP 310-a-2. In some aspects, and in accordance with first information pertaining to the downlink BWP 310-a-1 and the downlink BWP 310-a-2 of the serving cell 305-a, the downlink BWP 310-a-1 may be associated with monitoring for a DCI message 315-a (associated with a DCI format 2_6) to trigger a DRX active time and the downlink BWP 310-a-2 may be associated with monitoring for an LP-WUS 320-a to trigger a DRX active time. The serving cell 305-b may be associated with a downlink BWP 310-b-1 and a downlink BWP 310-b-2. In some aspects, and in accordance with second information pertaining to the downlink BWP 310-b-1 and the downlink BWP 310-b-2 of the serving cell 305-b, the downlink BWP 310-b-1 may be associated with monitoring for a DCI message 315-b (associated with a DCI format 2_6) to trigger a DRX active time and the downlink BWP 310-b-2 may be associated with monitoring for an LP-WUS 320-b to trigger a DRX active time.

In some aspects, the network entity 105 and the UE 115 may leverage the serving cell configuration 300 to define, provide, employ, or enforce one or more rules associated with configurations of DRX active time triggers across different serving cells. In some implementations, the network entity 105 may configure DRX active time triggers for the serving cell 305-a and the serving cell 305-b independently. In such implementations, the first information may indicate that the downlink BWP 310-a-1 is associated with monitoring for the DCI message 315-a to trigger a DRX active time and the downlink BWP 310-a-2 is associated with monitoring for an LP-WUS 320-a to trigger a DRX active time in accordance with a first RRC configuration structure and the second information may indicate that the downlink BWP 310-b-1 is associated with monitoring for the DCI message 315-b to trigger a DRX active time and the downlink BWP 310-b-2 is associated with monitoring for an LP-WUS 320-b to trigger a DRX active time in accordance with a second RRC configuration structure. The first RRC configuration may be the same as or different from the second RRC configuration structure.

As illustrated in the example of the serving cell configuration 300, the first information (e.g., the first RRC configuration structure) may indicate that the downlink BWP 310-a-1 is configured with a search space set for DCI format 2_6 monitoring and that the downlink BWP 310-a-2 is configured with one or more LP-WUS monitoring occasions. The second information (e.g., the second RRC configuration structure) may indicate that the downlink BWP 310-b-1 is configured with a search space set for DCI format 2_6 monitoring and that the serving cell 305-b is configured with one or more LP-WUS monitoring occasions (with the downlink BWP 310-a-2 absent of a search space set configuration for DCI format 2_6 monitoring). As described herein, an RRC configuration structure may refer to the levels at which one or more parameters are configured. For example, a first RRC configuration structure may be associated with configuring one or more parameters at the downlink BWP level and a second RRC configuration may be associated with configuring the one or more parameters at the serving cell level.

In some other implementations, the network entity 105 may configure DRX active time triggers for the serving cell 305-a and the serving cell 305-b in a same manner across both the serving cell 305-a and the serving cell 305-b. In such implementations, the first information may indicate that the downlink BWP 310-a-1 is associated with monitoring for the DCI message 315-a to trigger a DRX active time and the downlink BWP 310-a-2 is associated with monitoring for an LP-WUS 320-a to trigger a DRX active time in accordance with an RRC configuration structure and the second information may indicate that the downlink BWP 310-b-1 is associated with monitoring for the DCI message 315-b to trigger a DRX active time and the downlink BWP 310-b-2 is associated with monitoring for an LP-WUS 320-b to trigger a DRX active time in accordance with the same RRC configuration structure.

Additionally, or alternatively, the network entity 105 and the UE 115 may leverage the serving cell configuration 300 to define, provide, employ, configure, or enforce one or more rules associated with using different types of signaling to trigger a DRX active time. In some implementations, between cells in different cell groups, PUCCH groups, or DRX groups, there may be an absence of a restriction (e.g., no restriction) on simultaneous configuration or simultaneous usage of monitoring for a DCI format 2_6 or an LP-WUS to trigger a DRX active time. For example, when the downlink BWP 310-a-1 (e.g., the downlink BWP associated with monitoring for the DCI message 315-a to trigger a DRX active time) is the active downlink BWP of the serving cell 305-a, the downlink BWP 310-b-2 (e.g., the downlink BWP associated with monitoring for the LP-WUS 320-b to trigger a DRX active time) may be (e.g., is able to be) the active downlink BWP of the serving cell 305-b. In such implementations, the UE 115 may monitor for different types of DRX active time triggers across different cells (e.g., different serving cells) in different groups. In other words, the UE 115 may operate in accordance with a rule associated with simultaneously expecting that a DCI format 2_6 is to trigger a DRX active time in a first cell (e.g., the serving cell 305-a) and that an LP-WUS is to trigger a DRX active time in a second cell (e.g., the serving cell 305-b).

In some other implementations, between cells in different cell groups, PUCCH groups, or DRX groups, the network entity 105 or the UE 115 may expect that a usage of DCI format 2_6 and an LP-WUS to trigger a DRX active time is not simultaneous. In other words, the network entity 105 or the UE 115 may support or expect a restriction against simultaneously using DCI format 2_6 and an LP-WUS to trigger a DRX active time across cells (e.g., serving cells) of different groups of cells. For example, when the downlink BWP 310-a-1 (e.g., the downlink BWP associated with monitoring for the DCI message 315-a to trigger a DRX active time) is the active downlink BWP of the serving cell 305-a, the downlink BWP 310-b-2 (e.g., the downlink BWP associated with monitoring for the LP-WUS 320-b to trigger a DRX active time) may not be (e.g., is not able or expected to be) the active downlink BWP of the serving cell 305-b. In such examples, network entity 105 may employ a rule such that the network entity 105 avoids activating the downlink BWP 310-b-2 when the downlink BWP 310-a-1 is active. Additionally, or alternatively, the UE 115 may employ a rule such that the UE 115 interprets or classifies scenarios in which both the downlink BWP 310-a-1 and the downlink BWP 310-b-2 are active as an error case. In such scenarios, the UE 115 may refrain from monitoring for the DCI message 315-a or may refrain from monitoring for the LP-WUS 320-b to trigger a DRX active time (e.g., in accordance with a configured, signaled, or defined rule prioritizing one of DCI format 2_6 or LP-WUS monitoring).

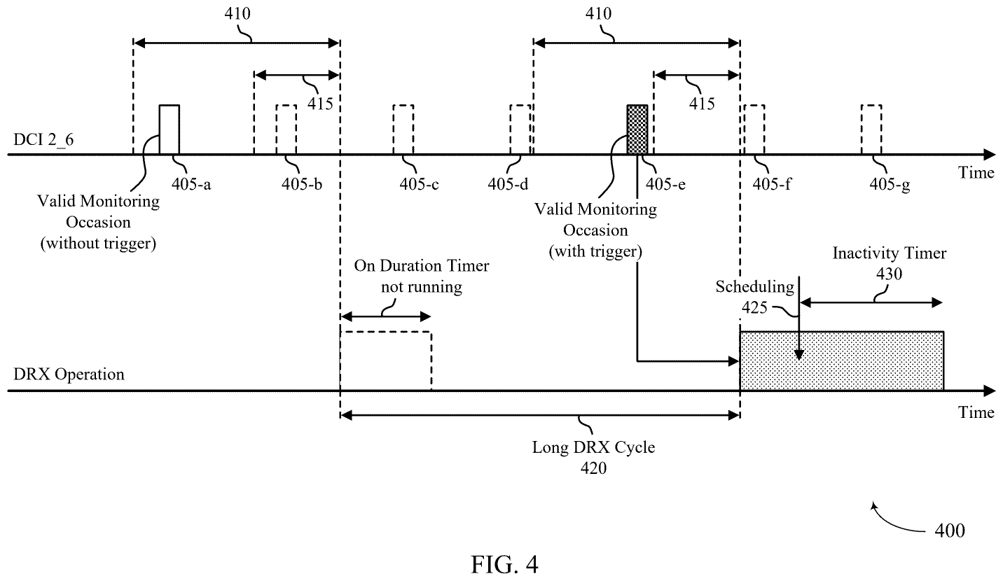

FIG. 4 shows an example communication timeline 400 that supports a configuration of a DRX active time trigger on a per downlink BWP basis in accordance with one or more aspects of the present disclosure. The communication timeline 400 may implement or be implemented to realize one or more aspects of the wireless communications system 100, the signaling diagram 200, or the serving cell configuration 300. For example, the communication timeline 400 illustrates communication between a network entity 105 and a UE 115, which may be examples of corresponding devices as illustrated and described herein, including by and with reference to FIGS. 1-3.

The communication timeline 400 illustrates examples in which the UE 115 monitors a search space set for DCI format 2_6 to trigger an active time of a DRX configuration or cycle. A configuration of the search space set for DCI format 2_6 may indicate information associated with a set of monitoring occasions via which a DCI message associated with DCI format 2_6 may be transmitted. As illustrated in the example of the communication timeline 400, such a set of monitoring occasions may include a monitoring occasion 405-a, a monitoring occasion 405-b, a monitoring occasion 405-c, a monitoring occasion 405-d, a monitoring occasion 405-e, a monitoring occasion 405-f, and a monitoring occasion 405-g.

Of the set of monitoring occasions, a subset of monitoring occasions may be valid monitoring occasions for an upcoming (e.g., next) long DRX cycle 420. For example, of the set of monitoring occasions, the monitoring occasion 405-a and the monitoring occasion 405-e may be valid monitoring occasions. A valid monitoring occasion may be defined as a monitoring occasion that falls or occurs within a time window defined by a time offset 410 (e.g., as indicated by ps-Offset) and a time gap 415 (e.g., a minimum gap) prior to a start of the next long DRX cycle 420. In other words, The UE 115 may monitor a PDCCH for DCI format 2_6 in PDCCH monitoring occasions (only) in a particular window prior to a slot in which the drx-onDurationTimer might start. The particular window for monitoring DCI format 2_6 may be identified by the RRC parameter ps-Offset and a minimum time gap until the first (e.g., initial) slot in which the drx-onDurationTimer might start. If there are multiple PDCCH monitoring occasions in the window, the UE 115 may monitor the DCI format 2_6 in the first (e.g., initial) PDCCH monitoring occasion(s) indicated by duration of the searchSpace configuration.

If a DCI message associated with DCI format 2_6 is received within a valid monitoring occasion and indicates the receiving UE 115 to wake up during the next long DRX cycle 420 (e.g., if the DCI message includes or is a trigger for the upcoming DRX active time), the UE 115 may wake up and monitor a PDCCH for scheduling 425 or other downlink signaling. In such scenarios, the UE 115 may start an on duration timer (e.g., a drx-onDurationTimer). Otherwise, the UE 115 may remain in a relatively lower power mode, such as an OFF or inactive state, and refrain from monitoring the PDCCH within the DRX active time of the upcoming long DRX cycle 420. In such scenarios, the UE 115 may refrain from starting the on duration timer (e.g., the drx-onDurationTimer).

Further, in examples in which the UE 115 receives scheduling 425 or other downlink signaling in association with monitoring a PDCCH within a DRX active time, the UE 115 may start an inactivity timer 430. The inactivity timer 430 may be associated with a duration defined or indicated by drx-InactivityTimer (e.g., an RRC parameter) and may define a time period after which the UE 115 may re-enter a relatively lower power mode, such as an OFF or inactive state (e.g., and stop or terminate PDCCH monitoring). The UE 115 may reset or restart the inactivity timer 430 each time the UE 115 receives downlink signaling when the UE 115 is in an ON or active state.

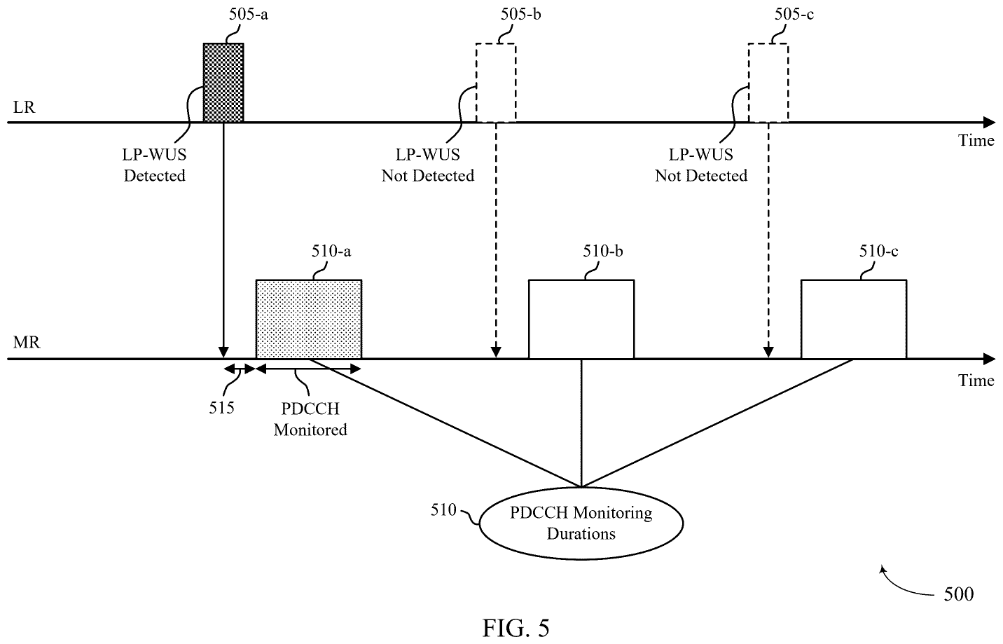

FIG. 5 shows an example communication timeline 500 that supports a configuration of a DRX active time trigger on a per downlink BWP basis in accordance with one or more aspects of the present disclosure. The communication timeline 500 may implement or be implemented to realize one or more aspects of the wireless communications system 100, the signaling diagram 200, or the serving cell configuration 300. The communication timeline 500 illustrates communication between a network entity 105 and a UE 115, which may be examples of corresponding devices as illustrated and described herein, including by and with reference to FIGS. 1-4.

The communication timeline 500 illustrates examples in which the UE 115 monitors for LP-WUSs via one or more monitoring occasions configured for LP-WUS monitoring. A configuration of the monitoring occasions for LP-WUSs may indicate information associated with a set of monitoring occasions via which an LP-WUS (to trigger a DRX active time) may be transmitted. As illustrated in the example of the communication timeline 500, such a set of monitoring occasions may include a monitoring occasion 505-a, a monitoring occasion 505-b, and a monitoring occasion 505-c.

In some aspects, the set of monitoring occasions may be associated with a periodicity equal to or approximately equal to a periodicity or cycle length of the DRX configuration at the UE 115 such that each monitoring occasion of the set of monitoring occasions precedes or corresponds to a PDCCH monitoring duration 510 (e.g., a DRX ON duration associated with the DRX configuration at the UE 115 or any other time window within which the UE 115 may selectively monitor a PDCCH). LP-WUS based PDCCH monitoring may be based on a DRX ON duration or another time window associated with PDCCH monitoring. In some examples, an LP-WUS may trigger PDCCH monitoring within a specific time window (e.g., a PDCCH monitoring duration 510) after a specific time offset from the LP-WUS monitoring occasion via which the LP-WUS is received. The time offset from the LP-WUS monitoring occasion may be equal to or larger than a threshold time duration. The threshold time duration may be specified by a network specification, reported by the UE 115 via UE capability signaling, or signaled by the network entity 105. Further, the time window for PDCCH monitoring (e.g., the PDCCH monitoring duration 510 after the time offset from the LP-WUS monitoring occasion) may be configured by the network entity 105 via control signaling, such as RRC signaling. The triggered PDCCH monitoring window may be a DRX ON duration associated with a DRX configuration at the UE 115 or another duration within which the UE 115 monitors PDCCH.

A PDCCH monitoring duration 510 (associated with a DRX configuration) may refer to a time window within which the UE 115 may enter an ON or active state (e.g., a time window within which the UE 115 may monitor PDCCH and/or start drx-onDurationTimer, among other examples). In some examples, the monitoring occasion 505-a may correspond to a PDCCH monitoring duration 510-a, the monitoring occasion 505-b may correspond to a PDCCH monitoring duration 510-b, and the monitoring occasion 505-cmay correspond to a PDCCH monitoring duration 510-c. In some aspects, each of the monitoring occasions may precede a corresponding PDCCH monitoring duration 510 by a time gap 515 (e.g., which may be understood or referred to as a minimum gap between an LP-WUS monitoring occasion and a corresponding PDCCH monitoring duration 510).

If an LP-WUS is received (e.g., detected) within a monitoring occasion, the UE 115 may wake up and monitor a PDCCH for scheduling or other downlink signaling. In such scenarios, the UE 115 may start an on duration timer (e.g., a drx-onDurationTimer). Otherwise, the UE 115 may remain in a relatively lower power mode, such as an OFF or inactive state, and refrain from monitoring the PDCCH (within, for example, the DRX active time of the upcoming long DRX cycle or some other time window within which the UE 115 may monitor PDCCH). In such scenarios, the UE 115 may refrain from starting the on duration timer (e.g., the drx-onDurationTimer). The UE 115 may monitor for an LP-WUS via one or more main (e.g., primary or relatively higher capability) radios of the UE 115 or via one or more auxiliary (e.g., secondary or relatively lower capability) radios of the UE 115.

Further, in examples in which the UE 115 receives scheduling or other downlink signaling in association with monitoring a PDCCH within a DRX active time, the UE 115 may start an inactivity timer. The inactivity timer may be associated with a duration defined or indicated by drx-InactivityTimer (e.g., an RRC parameter) and may define a time period after which the UE 115 may re-enter a relatively lower power mode, such as an OFF or inactive state (e.g., and stop or terminate PDCCH monitoring). The UE 115 may reset or restart the inactivity timer each time the UE 115 receives downlink signaling when the UE 115 is in an ON or active state.

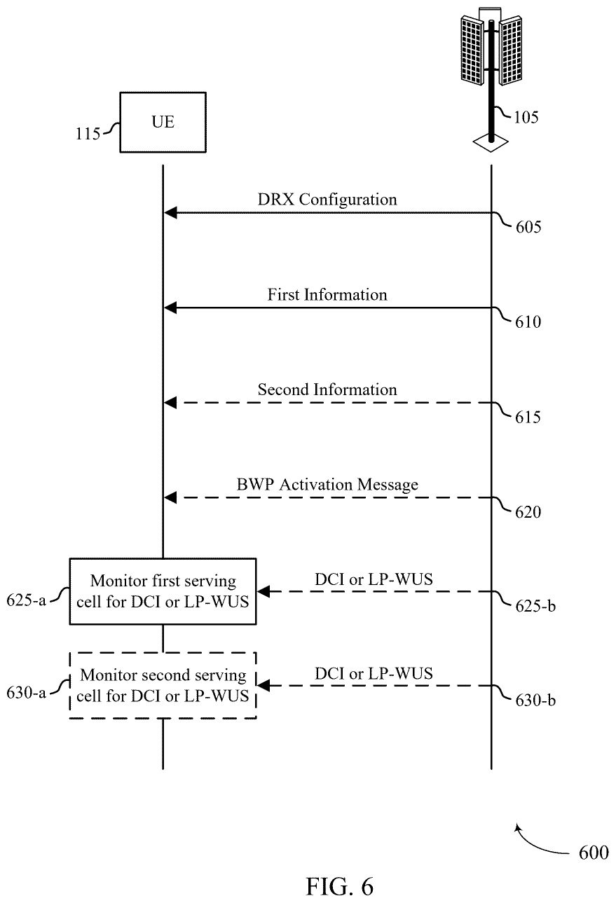

FIG. 6 shows an example process flow 600 that supports a configuration of a configuration of a DRX active time trigger on a per downlink BWP basis in accordance with one or more aspects of the present disclosure. The process flow 600 may implement or be implemented to realize one or more aspects of the wireless communications system 100, the signaling diagram 200, the serving cell configuration 300, the communication timeline 400, or the communication timeline 500. For example, the process flow 600 illustrates communication between a network entity 105 and a UE 115, which may be examples of corresponding devices as illustrated and described herein, including by and with reference to FIGS. 1-5.

Alternative examples of the following may be implemented. Some steps are performed in a different order than described or are not performed at all. In some implementations, steps may include additional features not mentioned below, or further steps may be added. Further, although example devices are shown performing the operations of the process flow 600, some aspects of some operations also may be performed by one or more other wireless communication devices without exceeding the scope of the present disclosure.

At 605, the UE 115 may receive, from the network entity 105, information indicative of one or more DRX configurations. The UE 115 may receive such information via RRC signaling. In some aspects, the information indicative of the one or more DRX configurations may indicate values of one or more parameters (e.g., RRC parameters) associated with the one or more DRX configurations, such as a values of a drx-onDurationTimer, a DRX cycle length, and a drx-Inactivity Timer, among other examples.

At 610, the UE 115 may receive, from the network entity 105, first information pertaining to a first set of downlink BWPs associated with a first serving cell. In some aspects, the first information may indicate that a first downlink BWP of the first set of downlink BWPs is associated with monitoring for a DCI message (e.g., DCI format 2_6) to trigger an active time associated with the DRX at the UE 115. Additionally, in some aspects, the first information may indicate that a second downlink BWP of the first set of downlink BWPs is associated with monitoring for an LP-WUS to trigger an active time associated with the DRX at the UE 115. The UE 115 and the network entity 105 may communicate the first information via one or more of various ways. For example, the UE 115 may receive the first information via one or more of RRC signaling, one or more MAC-CEs, one or more DCI messages, or any combination thereof. The first information may indicate that different BWPs are associated with different types of DRX active time triggers via one or more of various ways, as illustrated and described herein, including by and with reference to FIGS. 2 and 3.

At 615, the UE 115 may receive, from the network entity 105, second information pertaining to a second set of downlink BWPs associated with a second serving cell. In some aspects, the second information may indicate that a third downlink BWP of the second set of downlink BWPs is associated with monitoring for a DCI message (e.g., DCI format 2_6) to trigger an active time associated with the DRX at the UE 115. Additionally, in some aspects, the second information may indicate that a fourth downlink BWP of the second set of downlink BWPs is associated with monitoring for an LP-WUS to trigger an active time associated with the DRX at the UE 115. The UE 115 and the network entity 105 may communicate the second information via one or more of various ways. For example, the UE 115 may receive the second information via one or more of RRC signaling, one or more MAC-CEs, one or more DCI messages, or any combination thereof. The second information may indicate that different BWPs are associated with different types of DRX active time triggers via one or more of various mechanisms or RRC configuration structures, as illustrated and described herein, including by and with reference to FIGS. 2 and 3.

Further, in some implementations, the first information and the second information may indicate that different BWPs are associated with different types of DRX active time triggers via a same mechanism or RRC configuration structure. In some other implementations, the first information and the second information may indicate that different BWPs are associated with different types of DRX active time triggers via different (e.g., separately defined or independent) mechanisms or RRC configuration structures. Additional details relating to such conditional restrictions regarding DRX active time triggers across different serving cells are illustrated and described herein, including by and with reference to FIG. 3.

At 620, the UE 115 may receive, from the network entity 105, a BWP activation message. The BWP activation message may active one or more specific downlink BWPs of one or more sets of downlink BWPs configured at the UE 115. Additionally, or alternatively, the BWP activation message may indicate a pattern or schedule of active downlink BWPs, each downlink BWP associated with a time window (e.g., defined by a timer) within which that downlink BWP is the active downlink BWP. The UE 115 may receive the BWP activation message via one or more of RRC signaling, one or more MAC-CEs, one or more DCI messages, or any combination thereof.

At 625-a, the UE 115 may monitor (the first serving cell) for a DCI message or an LP-WUS to trigger a DRX active time in accordance with the first information and the BWP activation message. For example, if the first downlink BWP is the active downlink BWP of the first serving cell, the UE 115 may monitor for the DCI message to trigger the DRX active time. Alternatively, if the second downlink BWP is the active downlink BWP of the first serving cell, the UE 115 may monitor for the LP-WUS to trigger the DRX active time. In some implementations, the UE 115 may also consider one or more rules associated with simultaneous usage of DCI and LP-WUS monitoring to trigger a DRX active time across different serving cells (in examples in which the UE 115 supports and is configured with multiple serving cells in accordance with carrier aggregation (CA) or dual-connectivity (DC) operation). Additional details relating to such monitoring by the UE 115 are illustrated and described herein, including by and with reference to FIGS. 4 and 5.

Likewise, at 625-b, the network entity 105 may selectively transmit a DCI message or an LP-WUS to trigger the DRX active time in accordance with the first information and the BWP activation message. For example, if the first downlink BWP is the active downlink BWP of the first serving cell, the network entity 105 may selectively transmit the DCI message to trigger the DRX active time (with the network entity 105 transmitting the DCI message in examples in which the network entity 105 has downlink signaling ready or buffered for transmission to the UE 115). Alternatively, if the second downlink BWP is the active downlink BWP of the first serving cell, the network entity 105 may selectively transmit the LP-WUS to trigger the DRX active time (with the network entity 105 transmitting the LP-WUS in examples in which the network entity 105 has downlink signaling ready or buffered for transmission to the UE 115). In some implementations, the network entity 105 may also consider one or more rules associated with simultaneous usage of DCI and LP-WUS monitoring to trigger a DRX active time across different serving cells (in examples in which the UE 115 supports and is configured with multiple serving cells in accordance with CA or DC operation).

At 630-a, the UE 115 may monitor (the second serving cell) for a DCI message or an LP-WUS to trigger a DRX active time in accordance with the second information and the BWP activation message. For example, if the third downlink BWP is the active downlink BWP of the second serving cell, the UE 115 may monitor for the DCI message to trigger the DRX active time. Alternatively, if the fourth downlink BWP is the active downlink BWP of the second serving cell, the UE 115 may monitor for the LP-WUS to trigger the DRX active time. In some implementations, the UE 115 may also consider one or more rules associated with simultaneous usage of DCI and LP-WUS monitoring to trigger a DRX active time across different serving cells (in examples in which the UE 115 supports and is configured with multiple serving cells in accordance with CA or DC operation). Additional details relating to such monitoring by the UE 115 are illustrated and described herein, including by and with reference to FIGS. 4 and 5.

Likewise, at 630-b, the network entity 105 may selectively transmit a DCI message or an LP-WUS to trigger the DRX active time in accordance with the second information and the BWP activation message. For example, if the third downlink BWP is the active downlink BWP of the second serving cell, the network entity 105 may selectively transmit the DCI message to trigger the DRX active time (with the network entity 105 transmitting the DCI message in examples in which the network entity 105 has downlink signaling ready or buffered for transmission to the UE 115). Alternatively, if the fourth downlink BWP is the active downlink BWP of the second serving cell, the network entity 105 may selectively transmit the LP-WUS to trigger the DRX active time (with the network entity 105 transmitting the LP-WUS in examples in which the network entity 105 has downlink signaling ready or buffered for transmission to the UE 115). In some implementations, the network entity 105 may also consider one or more rules associated with simultaneous usage of DCI and LP-WUS monitoring to trigger a DRX active time across different serving cells (in examples in which the UE 115 supports and is configured with multiple serving cells in accordance with CA or DC operation).

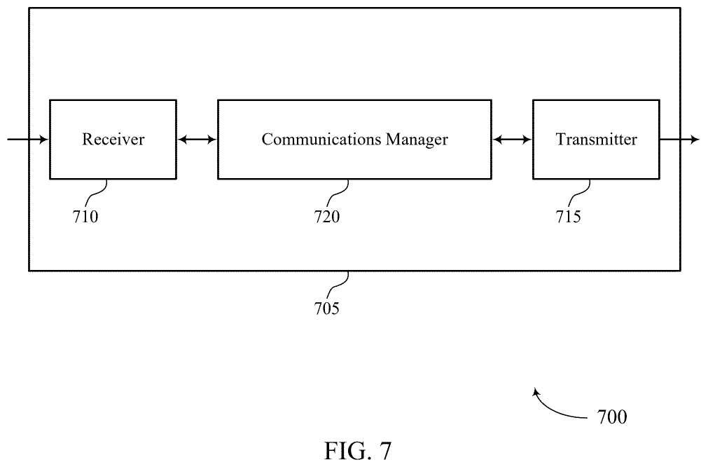

FIG. 7 shows a block diagram 700 of a device 705 that supports a configuration of a DRX active time trigger on a per downlink BWP basis in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to configuration of a DRX active time trigger on a per downlink BWP basis). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to configuration of a DRX active time trigger on a per downlink BWP basis). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of configuration of a DRX active time trigger on a per downlink BWP basis as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communication in accordance with examples as disclosed herein. For example, the communications manager 720 is capable of, configured to, or operable to support a means for receiving first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE. The communications manager 720 is capable of, configured to, or operable to support a means for monitoring for the DCI message or the wake-up signal in accordance with the first information and in accordance with which of the first downlink BWP or the second downlink BWP is an active downlink BWP of the first serving cell.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

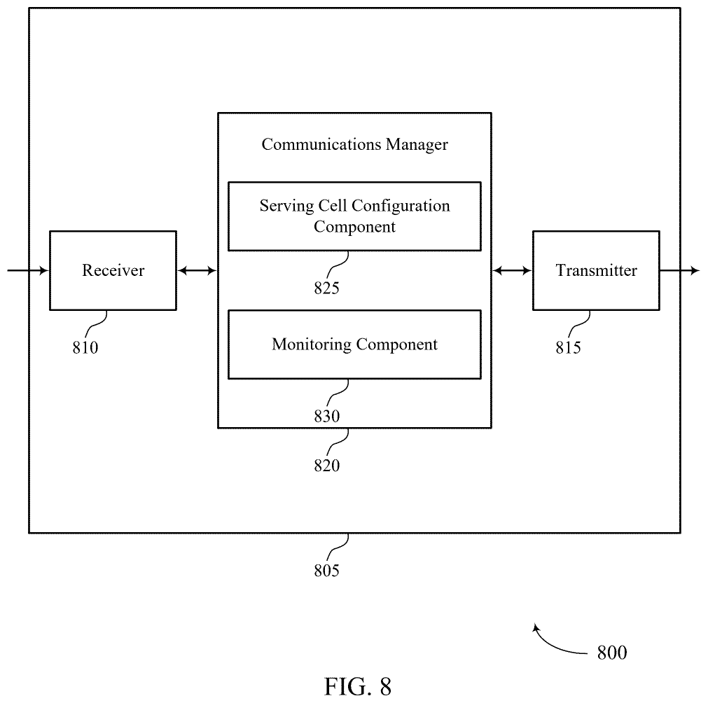

FIG. 8 shows a block diagram 800 of a device 805 that supports a configuration of a DRX active time trigger on a per downlink BWP basis in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to configuration of a DRX active time trigger on a per downlink BWP basis). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to configuration of a DRX active time trigger on a per downlink BWP basis). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of configuration of a DRX active time trigger on a per downlink BWP basis as described herein. For example, the communications manager 820 may include a serving cell configuration component 825 a monitoring component 830, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communication in accordance with examples as disclosed herein. The serving cell configuration component 825 is capable of, configured to, or operable to support a means for receiving first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE. The monitoring component 830 is capable of, configured to, or operable to support a means for monitoring for the DCI message or the wake-up signal in accordance with the first information and in accordance with which of the first downlink BWP or the second downlink BWP is an active downlink BWP of the first serving cell.

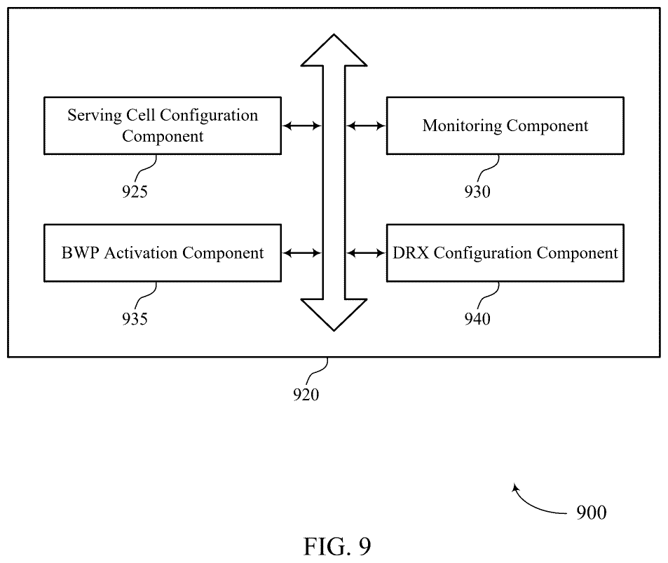

FIG. 9 shows a block diagram 900 of a communications manager 920 that supports a configuration of a DRX active time trigger on a per downlink BWP basis in accordance with one or more aspects of the present disclosure. The communications manager 920 may be an example of aspects of a communications manager 720, a communications manager 820, or both, as described herein. The communications manager 920, or various components thereof, may be an example of means for performing various aspects of configuration of a DRX active time trigger on a per downlink BWP basis as described herein. For example, the communications manager 920 may include a serving cell configuration component 925, a monitoring component 930, a BWP activation component 935, a DRX configuration component 940, or any combination thereof. Each of these components, or components or subcomponents thereof (e.g., one or more processors, one or more memories), may communicate, directly or indirectly, with one another (e.g., via one or more buses).

The communications manager 920 may support wireless communication in accordance with examples as disclosed herein. The serving cell configuration component 925 is capable of, configured to, or operable to support a means for receiving first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE. The monitoring component 930 is capable of, configured to, or operable to support a means for monitoring for the DCI message or the wake-up signal in accordance with the first information and in accordance with which of the first downlink BWP or the second downlink BWP is an active downlink BWP of the first serving cell.

In some examples, to support monitoring for the DCI message or the wake-up signal, the monitoring component 930 is capable of, configured to, or operable to support a means for monitoring for the DCI message to trigger the active time in accordance with the first downlink BWP being the active downlink BWP of the first serving cell. In some examples, to support monitoring for the DCI message or the wake-up signal, the monitoring component 930 is capable of, configured to, or operable to support a means for monitoring for the wake-up signal to trigger the active time in accordance with the second downlink BWP being the active downlink BWP of the first serving cell.

In some examples, the first information indicates that the first downlink BWP is configured with a search space set associated with the DCI message and that the second downlink BWP is configured with one or more monitoring occasions associated with the wake-up signal. In some examples, the first downlink BWP is associated with monitoring for the DCI message to trigger the active time in accordance with being configured with the search space set associated with the DCI message. In some examples, the second downlink BWP is associated with monitoring for the wake-up signal to trigger the active time in accordance with being configured with the one or more monitoring occasions associated with the wake-up signal.

In some examples, the first information indicates that the first downlink BWP is additionally configured with one or more second monitoring occasions associated with the wake-up signal, the first information further indicating that, of the DCI message and the wake-up signal, the first downlink BWP is to be associated with monitoring for the DCI message to trigger the active time; or that the second downlink BWP is additionally configured with a second search space set associated with the DCI message, the first information further indicating that, of the DCI message and the wake-up signal, the second downlink BWP is to be associated with monitoring for the wake-up signal to trigger the active time.

In some examples, the first information indicates that the first serving cell is configured with one or more monitoring occasions associated with the wake-up signal; that the first downlink BWP is configured with a search space set associated with the DCI message; and that the second downlink BWP is absent of a search space set configuration associated with the DCI message.

In some examples, the first downlink BWP is associated with monitoring for the DCI message to trigger the active time in accordance with being configured with the search space set associated with the DCI message. In some examples, the second downlink BWP is associated with monitoring for the wake-up signal to trigger the active time in accordance with being absent of the search space set configuration associated with the DCI message and in accordance with the first serving cell being configured with the one or more monitoring occasions associated with the wake-up signal.

In some examples, the serving cell configuration component 925 is capable of, configured to, or operable to support a means for receiving second information pertaining to a second set of multiple downlink BWPs associated with a second serving cell, where the second serving cell is associated with a different group of cells than the first serving cell, and where the second information indicates that a third downlink BWP of the second set of multiple downlink BWPs is associated with monitoring for the DCI message to trigger the active time associated with the DRX at the UE and that a fourth downlink BWP of the second set of multiple downlink BWPs is associated with monitoring for the wake-up signal to trigger the active time associated with the DRX at the UE.

In some examples, the second information indicates that the third downlink BWP is configured with a search space set associated with the DCI message and that the fourth downlink BWP is configured with one or more monitoring occasions associated with the wake-up signal. In some examples, the second information indicates that the second serving cell is configured with one or more monitoring occasions associated with the wake-up signal; that the third downlink BWP is configured with a search space set associated with the DCI message; and that the fourth downlink BWP is absent of a search space set configuration associated with the DCI message.

In some examples, the monitoring component 930 is capable of, configured to, or operable to support a means for monitoring the second serving cell for the DCI message or the wake-up signal in accordance with one or both of which of the third downlink BWP or the fourth downlink BWP is an active downlink BWP of the second serving cell or a rule associated with monitoring for DCI messages to trigger the active time and monitoring for wake-up signals to trigger the active time via different serving cells of different groups of cells.

In some examples, the rule indicates that the UE is able to monitor for DCI messages to trigger the active time and is able to monitor for wake-up signals to trigger the active time simultaneously via the different serving cells of the different groups of cells. In some examples, the rule indicates that the UE is to monitor for one of DCI messages or wake-up signals to trigger the active time across the different serving cells of the different groups of cells. In some examples, the different groups of cells are associated with a master cell group and a secondary cell group; a primary physical uplink control channel group and a secondary physical uplink control channel group; or a first DRX group and a second DRX group.

In some examples, the BWP activation component 935 is capable of, configured to, or operable to support a means for receiving a message that indicates that one of the first downlink BWP or the second downlink BWP is the active downlink BWP of the first serving cell. In some examples, the DRX configuration component 940 is capable of, configured to, or operable to support a means for receiving control signaling associated with a configuration of the DRX at the UE, where the configuration of the DRX is associated with at least the first serving cell. In some examples, the DCI message is associated with a DCI format 2_6. In some examples, the wake-up signal is associated with an LP-WUS waveform. In some examples, the active time associated with the DRX at the UE corresponds to a time window defined at least by a DRX on duration timer.

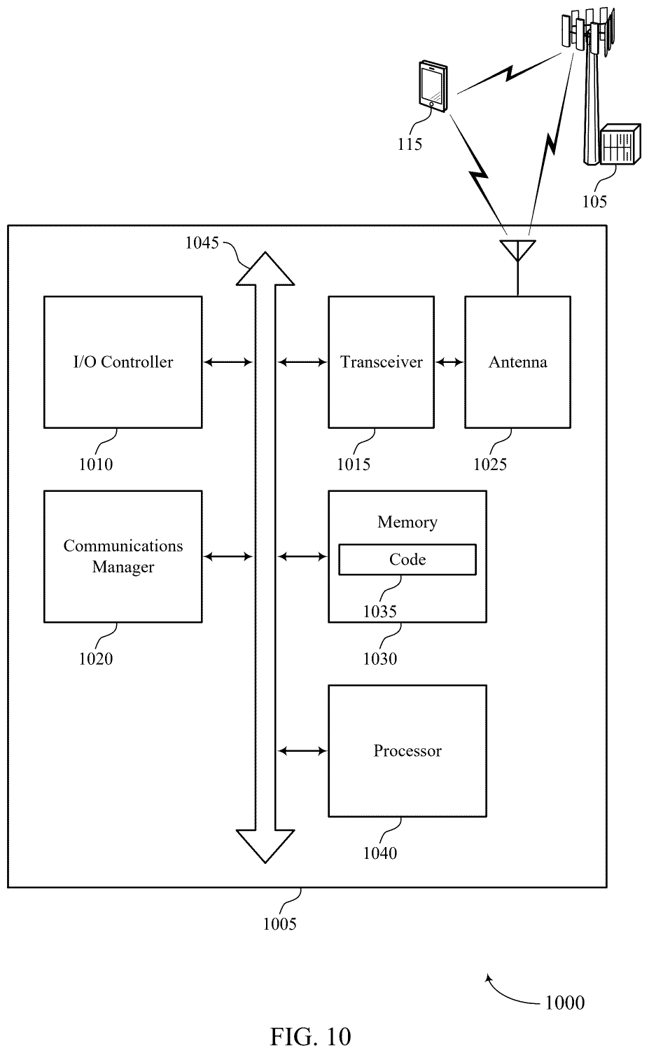

FIG. 10 shows a diagram of a system 1000 including a device 1005 that supports a configuration of a DRX active time trigger on a per downlink BWP basis in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting configuration of a DRX active time trigger on a per downlink BWP basis). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communication in accordance with examples as disclosed herein. For example, the communications manager 1020 is capable of, configured to, or operable to support a means for receiving first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE. The communications manager 1020 is capable of, configured to, or operable to support a means for monitoring for the DCI message or the wake-up signal in accordance with the first information and in accordance with which of the first downlink BWP or the second downlink BWP is an active downlink BWP of the first serving cell.

By including or configuring the communications manager 1020 in accordance with examples as described herein, the device 1005 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of configuration of a DRX active time trigger on a per downlink BWP basis as described herein, or the at least one processor 1040 and the at least one memory 1030 may be otherwise configured to, individually or collectively, perform or support such operations.

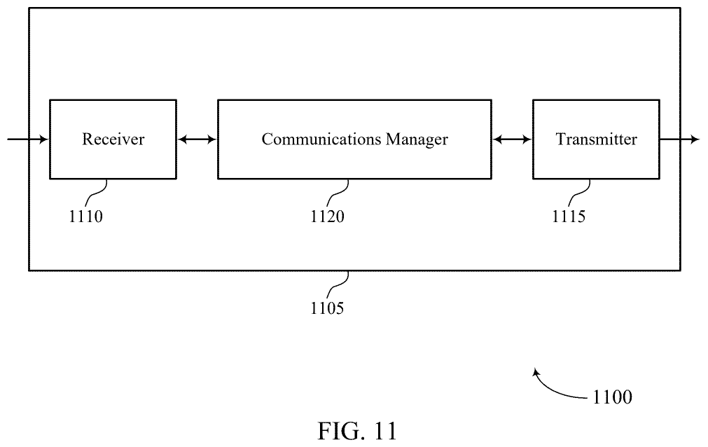

FIG. 11 shows a block diagram 1100 of a device 1105 that supports a configuration of a DRX active time trigger on a per downlink BWP basis in accordance with one or more aspects of the present disclosure. The device 1105 may be an example of aspects of a network entity 105 as described herein. The device 1105 may include a receiver 1110, a transmitter 1115, and a communications manager 1120. The device 1105, or one or more components of the device 1105 (e.g., the receiver 1110, the transmitter 1115, the communications manager 1120), may include at least one processor, which may be coupled with at least one memory, to, individually or collectively, support or enable the described techniques. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations or components thereof may be examples of means for performing various aspects of configuration of a DRX active time trigger on a per downlink BWP basis as described herein. For example, the communications manager 1120, the receiver 1110, the transmitter 1115, or various combinations or components thereof may be capable of performing one or more of the functions described herein.

In some examples, the communications manager 1120, the receiver 1110, the transmitter 1115, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 1120, the receiver 1110, the transmitter 1115, or various combinations or components thereof may be implemented in code (e.g., as communications management software or firmware) executed by at least one processor (e.g., referred to as a processor-executable code). If implemented in code executed by at least one processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communication in accordance with examples as disclosed herein. For example, the communications manager 1120 is capable of, configured to, or operable to support a means for transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE. The communications manager 1120 is capable of, configured to, or operable to support a means for transmitting the DCI message or the wake-up signal in accordance with the first information and in accordance with which of the first downlink BWP or the second downlink BWP is an active downlink BWP of the first serving cell.

By including or configuring the communications manager 1120 in accordance with examples as described herein, the device 1105 (e.g., at least one processor controlling or otherwise coupled with the receiver 1110, the transmitter 1115, the communications manager 1120, or a combination thereof) may support techniques for reduced processing, reduced power consumption, and more efficient utilization of communication resources.

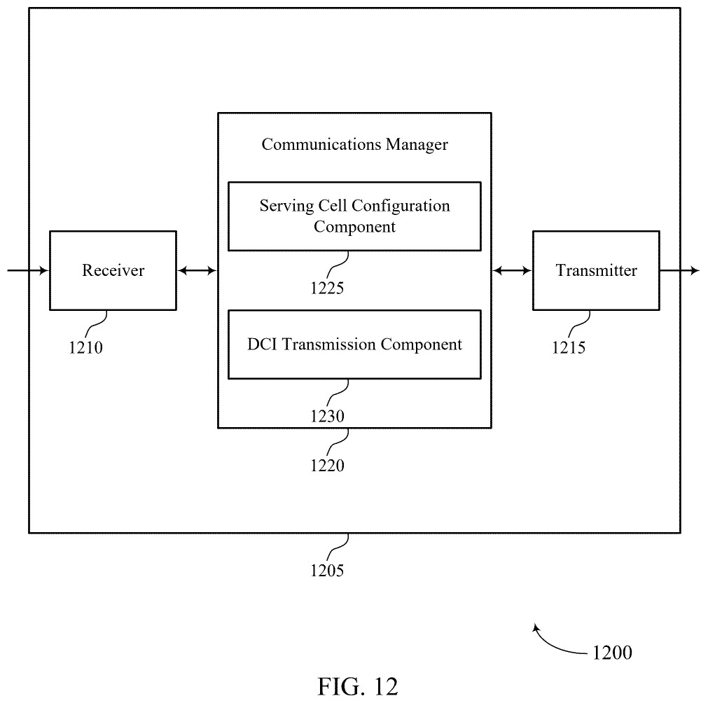

FIG. 12 shows a block diagram 1200 of a device 1205 that supports a configuration of a DRX active time trigger on a per downlink BWP basis in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205, or one or more components of the device 1205 (e.g., the receiver 1210, the transmitter 1215, the communications manager 1220), may include at least one processor, which may be coupled with at least one memory, to support the described techniques. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of configuration of a DRX active time trigger on a per downlink BWP basis as described herein. For example, the communications manager 1220 may include a serving cell configuration component 1225 a DCI transmission component 1230, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communication in accordance with examples as disclosed herein. The serving cell configuration component 1225 is capable of, configured to, or operable to support a means for transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE. The DCI transmission component 1230 is capable of, configured to, or operable to support a means for transmitting the DCI message or the wake-up signal in accordance with the first information and in accordance with which of the first downlink BWP or the second downlink BWP is an active downlink BWP of the first serving cell.

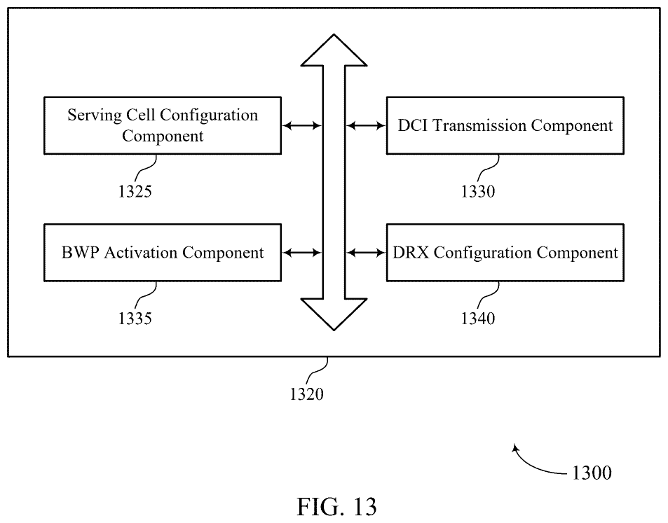

FIG. 13 shows a block diagram 1300 of a communications manager 1320 that supports a configuration of a DRX active time trigger on a per downlink BWP basis in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of configuration of a DRX active time trigger on a per downlink BWP basis as described herein. For example, the communications manager 1320 may include a serving cell configuration component 1325, a DCI transmission component 1330, a BWP activation component 1335, a DRX configuration component 1340, or any combination thereof. Each of these components, or components or subcomponents thereof (e.g., one or more processors, one or more memories), may communicate, directly or indirectly, with one another (e.g., via one or more buses). The communications may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communication in accordance with examples as disclosed herein. The serving cell configuration component 1325 is capable of, configured to, or operable to support a means for transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE. The DCI transmission component 1330 is capable of, configured to, or operable to support a means for transmitting the DCI message or the wake-up signal in accordance with the first information and in accordance with which of the first downlink BWP or the second downlink BWP is an active downlink BWP of the first serving cell.

In some examples, to support transmitting the DCI message or the wake-up signal, the DCI transmission component 1330 is capable of, configured to, or operable to support a means for transmitting the DCI message to trigger the active time in accordance with the first downlink BWP being the active downlink BWP of the first serving cell. In some examples, to support transmitting the DCI message or the wake-up signal, the DCI transmission component 1330 is capable of, configured to, or operable to support a means for transmitting the wake-up signal to trigger the active time in accordance with the second downlink BWP being the active downlink BWP of the first serving cell.

In some examples, the first information indicates that the first downlink BWP is configured with a search space set associated with the DCI message and that the second downlink BWP is configured with one or more monitoring occasions associated with the wake-up signal. In some examples, the first downlink BWP is associated with transmission of the DCI message to trigger the active time in accordance with being configured with the search space set associated with the DCI message. In some examples, the second downlink BWP is associated with transmission of the wake-up signal to trigger the active time in accordance with being configured with the one or more monitoring occasions associated with the wake-up signal.

In some examples, the first information indicates that the first downlink BWP is additionally configured with one or more second monitoring occasions associated with the wake-up signal, the first information further indicating that, of the DCI message and the wake-up signal, the first downlink BWP is to be associated with transmission of the DCI message to trigger the active time; or that the second downlink BWP is additionally configured with a second search space set associated with the DCI message, the first information further indicating that, of the DCI message and the wake-up signal, the second downlink BWP is to be associated with transmission of the wake-up signal to trigger the active time.

In some examples, the first information indicates that the first serving cell is configured with one or more monitoring occasions associated with the wake-up signal; that the first downlink BWP is configured with a search space set associated with the DCI message; and that the second downlink BWP is absent of a search space set configuration associated with the DCI message. In some examples, the first downlink BWP is associated with transmission of the DCI message to trigger the active time in accordance with being configured with the search space set associated with the DCI message. In some examples, the second downlink BWP is associated with transmission of the wake-up signal to trigger the active time in accordance with being absent of the search space set configuration associated with the DCI message and in accordance with the first serving cell being configured with the one or more monitoring occasions associated with the wake-up signal.

In some examples, the serving cell configuration component 1325 is capable of, configured to, or operable to support a means for transmitting second information pertaining to a second set of multiple downlink BWPs associated with a second serving cell, where the second serving cell is associated with a different group of cells than the first serving cell, and where the second information indicates that a third downlink BWP of the second set of multiple downlink BWPs is associated with transmission of the DCI message to trigger the active time associated with the DRX at the UE and that a fourth downlink BWP of the second set of multiple downlink BWPs is associated with transmission of the wake-up signal to trigger the active time associated with the DRX at the UE.

In some examples, the second information indicates that the third downlink BWP is configured with a search space set associated with the DCI message and that the fourth downlink BWP is configured with one or more monitoring occasions associated with the wake-up signal. In some examples, the second information indicates that the second serving cell is configured with one or more monitoring occasions associated with the wake-up signal; that the third downlink BWP is configured with a search space set associated with the DCI message; and that the fourth downlink BWP is absent of a search space set configuration associated with the DCI message.

In some examples, the DCI transmission component 1330 is capable of, configured to, or operable to support a means for transmitting, via the second serving cell, the DCI message or the wake-up signal in accordance with one or both of which of the third downlink BWP or the fourth downlink BWP is an active downlink BWP of the second serving cell or a rule associated with monitoring for DCI messages to trigger the active time and monitoring for wake-up signals to trigger the active time via different serving cells of different groups of cells.

In some examples, the rule indicates that the network entity is able to transmit DCI messages to trigger the active time and is able to transmit wake-up signals to trigger the active time simultaneously via the different serving cells of the different groups of cells. In some examples, the rule indicates that the network entity is to transmit one of DCI messages or wake-up signals to trigger the active time across the different serving cells of the different groups of cells. In some examples, the different groups of cells are associated with a master cell group and a secondary cell group; a primary physical uplink control channel group and a secondary physical uplink control channel group; or a first DRX group and a second DRX group.

In some examples, the BWP activation component 1335 is capable of, configured to, or operable to support a means for transmitting a message that indicates that one of the first downlink BWP or the second downlink BWP is the active downlink BWP of the first serving cell. In some examples, the DRX configuration component 1340 is capable of, configured to, or operable to support a means for transmitting control signaling associated with a configuration of the DRX at the UE, where the configuration of the DRX is associated with at least the first serving cell. In some examples, the DCI message is associated with a DCI format 2_6; the wake-up signal is associated with LP-WUS waveform; and the active time associated with the DRX at the UE corresponds to a time window defined at least by a DRX on duration timer.

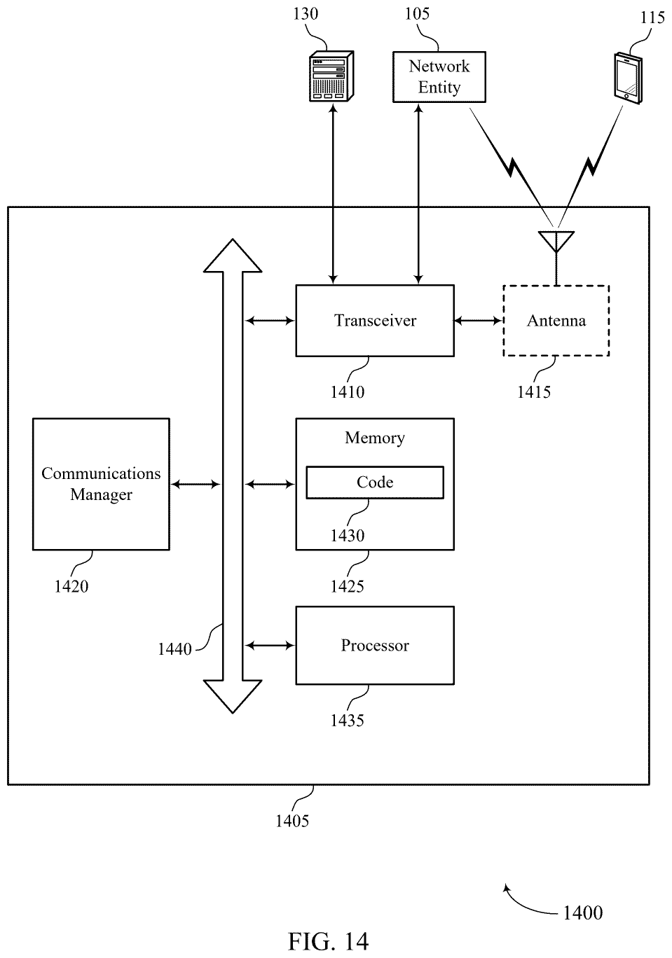

FIG. 14 shows a diagram of a system 1400 including a device 1405 that supports a configuration of a DRX active time trigger on a per downlink BWP basis in accordance with one or more aspects of the present disclosure. The device 1405 may be an example of or include components of a device 1105, a device 1205, or a network entity 105 as described herein. The device 1405 may communicate with other network devices or network equipment such as one or more of the network entities 105, UEs 115, or any combination thereof. The communications may include communications over one or more wired interfaces, over one or more wireless interfaces, or any combination thereof. The device 1405 may include components that support outputting and obtaining communications, such as a communications manager 1420, a transceiver 1410, one or more antennas 1415, at least one memory 1425, code 1430, and at least one processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. In some implementations, the transceiver 1410 may include one or more interfaces, such as one or more interfaces coupled with the one or more antennas 1415 that are configured to support various receiving or obtaining operations, or one or more interfaces coupled with the one or more antennas 1415 that are configured to support various transmitting or outputting operations, or a combination thereof. In some implementations, the transceiver 1410 may include or be configured for coupling with one or more processors or one or more memory components that are operable to perform or support operations based on received or obtained information or signals, or to generate information or other signals for transmission or other outputting, or any combination thereof. In some implementations, the transceiver 1410, or the transceiver 1410 and the one or more antennas 1415, or the transceiver 1410 and the one or more antennas 1415 and one or more processors or one or more memory components (e.g., the at least one processor 1435, the at least one memory 1425, or both), may be included in a chip or chip assembly that is installed in the device 1405. In some examples, the transceiver 1410 may be operable to support communications via one or more communications links (e.g., communication link(s) 125, backhaul communication link(s) 120, a midhaul communication link 162, a fronthaul communication link 168).

The at least one memory 1425 may include RAM, ROM, or any combination thereof. The at least one memory 1425 may store computer-readable, computer-executable, or processor-executable code, such as the code 1430. The code 1430 may include instructions that, when executed by one or more of the at least one processor 1435, cause the device 1405 to perform various functions described herein. The code 1430 may be stored in a non-transitory computer-readable medium such as system memory or another type of memory. In some cases, the code 1430 may not be directly executable by a processor of the at least one processor 1435 but may cause a computer (e.g., when compiled and executed) to perform functions described herein. In some cases, the at least one memory 1425 may include, among other things, a BIOS which may control basic hardware or software operation such as the interaction with peripheral components or devices. In some examples, the at least one processor 1435 may include multiple processors and the at least one memory 1425 may include multiple memories. One or more of the multiple processors may be coupled with one or more of the multiple memories which may, individually or collectively, be configured to perform various functions herein (for example, as part of a processing system).

The at least one processor 1435 may include one or more intelligent hardware devices (e.g., one or more general-purpose processors, one or more DSPs, one or more CPUs, one or more GPUs, one or more NPUs (also referred to as neural network processors or DLPs), one or more microcontrollers, one or more ASICs, one or more FPGAs, one or more programmable logic devices, discrete gate or transistor logic, one or more discrete hardware components, or any combination thereof). In some cases, the at least one processor 1435 may be configured to operate a memory array using a memory controller. In some other cases, a memory controller may be integrated into one or more of the at least one processor 1435. The at least one processor 1435 may be configured to execute computer-readable instructions stored in a memory (e.g., one or more of the at least one memory 1425) to cause the device 1405 to perform various functions (e.g., functions or tasks supporting configuration of a DRX active time trigger on a per downlink BWP basis). For example, the device 1405 or a component of the device 1405 may include at least one processor 1435 and at least one memory 1425 coupled with one or more of the at least one processor 1435, the at least one processor 1435 and the at least one memory 1425 configured to perform various functions described herein. The at least one processor 1435 may be an example of a cloud-computing platform (e.g., one or more physical nodes and supporting software such as operating systems, virtual machines, or container instances) that may host the functions (e.g., by executing code 1430) to perform the functions of the device 1405. The at least one processor 1435 may be any one or more suitable processors capable of executing scripts or instructions of one or more software programs stored in the device 1405 (such as within one or more of the at least one memory 1425).

In some examples, the at least one processor 1435 may include multiple processors and the at least one memory 1425 may include multiple memories. One or more of the multiple processors may be coupled with one or more of the multiple memories, which may, individually or collectively, be configured to perform various functions herein. In some examples, the at least one processor 1435 may be a component of a processing system, which may refer to a system (such as a series) of machines, circuitry (including, for example, one or both of processor circuitry (which may include the at least one processor 1435) and memory circuitry (which may include the at least one memory 1425)), or components, that receives or obtains inputs and processes the inputs to produce, generate, or obtain a set of outputs. The processing system may be configured to perform one or more of the functions described herein. For example, the at least one processor 1435 or a processing system including the at least one processor 1435 may be configured to, configurable to, or operable to cause the device 1405 to perform one or more of the functions described herein. Further, as described herein, being “configured to,” being “configurable to,” and being “operable to” may be used interchangeably and may be associated with a capability, when executing code stored in the at least one memory 1425 or otherwise, to perform one or more of the functions described herein.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the at least one memory 1425, the code 1430, and the at least one processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with one or more other network entities 105, and may include a controller or scheduler for controlling communications with UEs 115 (e.g., in cooperation with the one or more other network devices). In some examples, the communications manager 1420 may support an X2 interface within an LTE/LTE-A wireless communications network technology to provide communication between network entities 105.

The communications manager 1420 may support wireless communication in accordance with examples as disclosed herein. For example, the communications manager 1420 is capable of, configured to, or operable to support a means for transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE. The communications manager 1420 is capable of, configured to, or operable to support a means for transmitting the DCI message or the wake-up signal in accordance with the first information and in accordance with which of the first downlink BWP or the second downlink BWP is an active downlink BWP of the first serving cell.

By including or configuring the communications manager 1420 in accordance with examples as described herein, the device 1405 may support techniques for improved communication reliability, reduced latency, improved user experience related to reduced processing, reduced power consumption, more efficient utilization of communication resources, improved coordination between devices, longer battery life, and improved utilization of processing capability.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the transceiver 1410, one or more of the at least one processor 1435, one or more of the at least one memory 1425, the code 1430, or any combination thereof (for example, by a processing system including at least a portion of the at least one processor 1435, the at least one memory 1425, the code 1430, or any combination thereof). For example, the code 1430 may include instructions executable by one or more of the at least one processor 1435 to cause the device 1405 to perform various aspects of configuration of a DRX active time trigger on a per downlink BWP basis as described herein, or the at least one processor 1435 and the at least one memory 1425 may be otherwise configured to, individually or collectively, perform or support such operations.

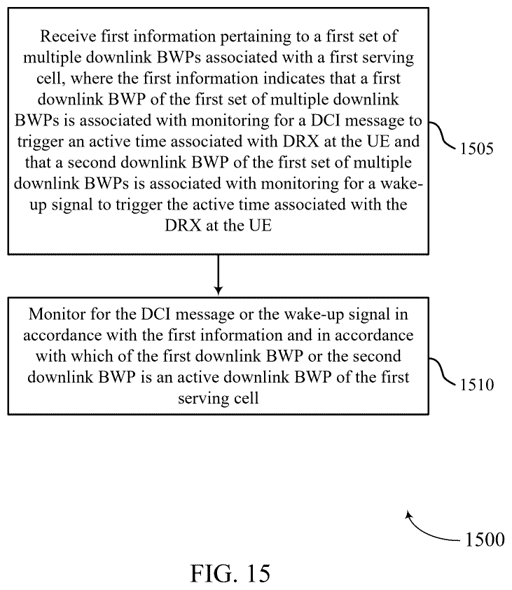

FIG. 15 shows a flowchart illustrating a method 1500 that supports a configuration of a DRX active time trigger on a per downlink BWP basis in accordance with one or more aspects of the present disclosure. The operations of the method 1500 may be implemented by a UE or its components as described herein. For example, the operations of the method 1500 may be performed by a UE 115 as described with reference to FIGS. 1-10. In some examples, a UE may execute a set of instructions to control the functional elements of the UE to perform the described functions. Additionally, or alternatively, the UE may perform aspects of the described functions using special-purpose hardware.

At 1505, the method may include receiving first information pertaining to a first set of multiple downlink BWPs associated with a first serving cell, where the first information indicates that a first downlink BWP of the first set of multiple downlink BWPs is associated with monitoring for a DCI message to trigger an active time associated with DRX at the UE and that a second downlink BWP of the first set of multiple downlink BWPs is associated with monitoring for a wake-up signal to trigger the active time associated with the DRX at the UE. The operations of 1505 may be performed in accordance with examples as disclosed herein. In some examples, aspects of the operations of 1505 may be performed by a serving cell configuration component 925 as described with reference to FIG. 9.

At 1510, the method may include monitoring for the DCI message or the wake-up signal in accordance with the first information and in accordance with which of the first downlink BWP or the second downlink BWP is an active downlink BWP of the first serving cell. The operations of 1510 may be performed in accordance with examples as disclosed herein. In some examples, aspects of the operations of 1510 may be performed by a monitoring component 930 as described with reference to FIG. 9.

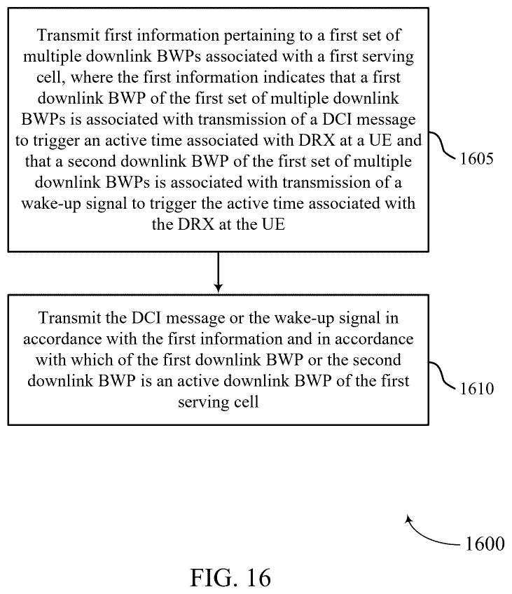

FIG. 16 shows a flowchart illustrating a method 1600 that supports a configuration of a DRX active time trigger on a per downlink BWP basis in accordance with one or more aspects of the present disclosure. The operations of the method 1600 may be implemented by a network entity or its components as described herein. For example, the operations of the method 1600 may be performed by a network entity as described with reference to FIGS. 1-6 and 11-14. In some examples, a network entity may execute a set of instructions to control the functional elements of the network entity to perform the described functions. Additionally, or alternatively, the network entity may perform aspects of the described functions using special-purpose hardware.

At 1605, the method may include transmitting first information pertaining to a first set of multiple downlink BWPs associated with a first serving cell, where the first information indicates that a first downlink BWP of the first set of multiple downlink BWPs is associated with transmission of a DCI message to trigger an active time associated with DRX at a UE and that a second downlink BWP of the first set of multiple downlink BWPs is associated with transmission of a wake-up signal to trigger the active time associated with the DRX at the UE. The operations of 1605 may be performed in accordance with examples as disclosed herein. In some examples, aspects of the operations of 1605 may be performed by a serving cell configuration component 1325 as described with reference to FIG. 13.

At 1610, the method may include transmitting the DCI message or the wake-up signal in accordance with the first information and in accordance with which of the first downlink BWP or the second downlink BWP is an active downlink BWP of the first serving cell. The operations of 1610 may be performed in accordance with examples as disclosed herein. In some examples, aspects of the operations of 1610 may be performed by a DCI transmission component 1330 as described with reference to FIG. 13.

The following provides an overview of aspects of the present disclosure:

Aspect 1: A method for wireless communication at a UE, comprising: receiving first information pertaining to a first plurality of downlink BWPs associated with a first serving cell, wherein the first information indicates that a first downlink BWP of the first plurality of downlink BWPs is associated with monitoring for a DCI message to trigger an active time associated with DRX at the UE and that a second downlink BWP of the first plurality of downlink BWPs is associated with monitoring for a wake-up signal to trigger the active time associated with the DRX at the UE; and monitoring for the DCI message or the wake-up signal in accordance with the first information and in accordance with which of the first downlink BWP or the second downlink BWP is an active downlink BWP of the first serving cell.

Aspect 2: The method of aspect 1, wherein monitoring for the DCI message or the wake-up signal comprises: monitoring for the DCI message to trigger the active time in accordance with the first downlink BWP being the active downlink BWP of the first serving cell; or monitoring for the wake-up signal to trigger the active time in accordance with the second downlink BWP being the active downlink BWP of the first serving cell.

Aspect 3: The method of any of aspects 1-2, wherein the first information indicates that the first downlink BWP is configured with a search space set associated with the DCI message and that the second downlink BWP is configured with one or more monitoring occasions associated with the wake-up signal.

Aspect 4: The method of aspect 3, wherein the first downlink BWP is associated with monitoring for the DCI message to trigger the active time in accordance with being configured with the search space set associated with the DCI message, and the second downlink BWP is associated with monitoring for the wake-up signal to trigger the active time in accordance with being configured with the one or more monitoring occasions associated with the wake-up signal.

Aspect 5: The method of any of aspects 3-4, wherein the first information indicates that the first downlink BWP is additionally configured with one or more second monitoring occasions associated with the wake-up signal, the first information further indicating that, of the DCI message and the wake-up signal, the first downlink BWP is to be associated with monitoring for the DCI message to trigger the active time; or that the second downlink BWP is additionally configured with a second search space set associated with the DCI message, the first information further indicating that, of the DCI message and the wake-up signal, the second downlink BWP is to be associated with monitoring for the wake-up signal to trigger the active time.

Aspect 6: The method of any of aspects 1-5, wherein the first information indicates that the first serving cell is configured with one or more monitoring occasions associated with the wake-up signal; that the first downlink BWP is configured with a search space set associated with the DCI message; and that the second downlink BWP is absent of a search space set configuration associated with the DCI message.

Aspect 7: The method of aspect 6, wherein the first downlink BWP is associated with monitoring for the DCI message to trigger the active time in accordance with being configured with the search space set associated with the DCI message, and the second downlink BWP is associated with monitoring for the wake-up signal to trigger the active time in accordance with being absent of the search space set configuration associated with the DCI message and in accordance with the first serving cell being configured with the one or more monitoring occasions associated with the wake-up signal.

Aspect 8: The method of any of aspects 1-7, further comprising: receiving second information pertaining to a second plurality of downlink BWPs associated with a second serving cell, wherein the second serving cell is associated with a different group of cells than the first serving cell, and wherein the second information indicates that a third downlink BWP of the second plurality of downlink BWPs is associated with monitoring for the DCI message to trigger the active time associated with the DRX at the UE and that a fourth downlink BWP of the second plurality of downlink BWPs is associated with monitoring for the wake-up signal to trigger the active time associated with the DRX at the UE.

Aspect 9: The method of aspect 8, wherein the second information indicates that the third downlink BWP is configured with a search space set associated with the DCI message and that the fourth downlink BWP is configured with one or more monitoring occasions associated with the wake-up signal.

Aspect 10: The method of any of aspects 8-9, wherein the second information indicates that the second serving cell is configured with one or more monitoring occasions associated with the wake-up signal; that the third downlink BWP is configured with a search space set associated with the DCI message; and that the fourth downlink BWP is absent of a search space set configuration associated with the DCI message.

Aspect 11: The method of any of aspects 8-10, further comprising: monitoring the second serving cell for the DCI message or the wake-up signal in accordance with one or both of which of the third downlink BWP or the fourth downlink BWP is an active downlink BWP of the second serving cell or a rule associated with monitoring for DCI messages to trigger the active time and monitoring for wake-up signals to trigger the active time via different serving cells of different groups of cells.

Aspect 12: The method of aspect 11, wherein the rule indicates that the UE is able to monitor for DCI messages to trigger the active time and is able to monitor for wake-up signals to trigger the active time simultaneously via the different serving cells of the different groups of cells.

Aspect 13: The method of aspect 11, wherein the rule indicates that the UE is to monitor for one of DCI messages or wake-up signals to trigger the active time across the different serving cells of the different groups of cells.

Aspect 14: The method of any of aspects 11-13, wherein the different groups of cells are associated with an MCG and an SCG; a primary PUCCH group and a secondary PUCCH group; or a first DRX group and a second DRX group.

Aspect 15: The method of any of aspects 1-14, further comprising: receiving a message that indicates that one of the first downlink BWP or the second downlink BWP is the active downlink BWP of the first serving cell.

Aspect 16: The method of any of aspects 1-15, further comprising: receiving control signaling associated with a configuration of the DRX at the UE, wherein the configuration of the DRX is associated with at least the first serving cell.

Aspect 17: The method of any of aspects 1-16, wherein the DCI message is associated with a DCI format 2_6; the wake-up signal is associated with an LP-WUS waveform; and the active time associated with the DRX at the UE corresponds to a time window defined at least by a DRX on duration timer.

Aspect 18: A method for wireless communication at a network entity, comprising: transmitting first information pertaining to a first plurality of downlink BWPs associated with a first serving cell, wherein the first information indicates that a first downlink BWP of the first plurality of downlink BWPs is associated with transmission of a DCI message to trigger an active time associated with DRX at a UE and that a second downlink BWP of the first plurality of downlink BWPs is associated with transmission of a wake-up signal to trigger the active time associated with the DRX at the UE; and transmitting the DCI message or the wake-up signal in accordance with the first information and in accordance with which of the first downlink BWP or the second downlink BWP is an active downlink BWP of the first serving cell.

Aspect 19: The method of aspect 18, wherein transmitting the DCI message or the wake-up signal comprises: transmitting the DCI message to trigger the active time in accordance with the first downlink BWP being the active downlink BWP of the first serving cell; or transmitting the wake-up signal to trigger the active time in accordance with the second downlink BWP being the active downlink BWP of the first serving cell.

Aspect 20: The method of any of aspects 18-19, wherein the first information indicates that the first downlink BWP is configured with a search space set associated with the DCI message and that the second downlink BWP is configured with one or more monitoring occasions associated with the wake-up signal.

Aspect 21: The method of aspect 20, wherein the first downlink BWP is associated with transmission of the DCI message to trigger the active time in accordance with being configured with the search space set associated with the DCI message; and the second downlink BWP is associated with transmission of the wake-up signal to trigger the active time in accordance with being configured with the one or more monitoring occasions associated with the wake-up signal.

Aspect 22: The method of any of aspects 20-21, wherein the first information indicates that the first downlink BWP is additionally configured with one or more second monitoring occasions associated with the wake-up signal, the first information further indicating that, of the DCI message and the wake-up signal, the first downlink BWP is to be associated with transmission of the DCI message to trigger the active time; or that the second downlink BWP is additionally configured with a second search space set associated with the DCI message, the first information further indicating that, of the DCI message and the wake-up signal, the second downlink BWP is to be associated with transmission of the wake-up signal to trigger the active time.

Aspect 23: The method of any of aspects 18-22, wherein the first information indicates that the first serving cell is configured with one or more monitoring occasions associated with the wake-up signal; that the first downlink BWP is configured with a search space set associated with the DCI message; and that the second downlink BWP is absent of a search space set configuration associated with the DCI message.

Aspect 24: The method of aspect 23, wherein the first downlink BWP is associated with transmission of the DCI message to trigger the active time in accordance with being configured with the search space set associated with the DCI message; and the second downlink BWP is associated with transmission of the wake-up signal to trigger the active time in accordance with being absent of the search space set configuration associated with the DCI message and in accordance with the first serving cell being configured with the one or more monitoring occasions associated with the wake-up signal.

Aspect 25: The method of any of aspects 18-24, further comprising: transmitting second information pertaining to a second plurality of downlink BWPs associated with a second serving cell, wherein the second serving cell is associated with a different group of cells than the first serving cell, and wherein the second information indicates that a third downlink BWP of the second plurality of downlink BWPs is associated with transmission of the DCI message to trigger the active time associated with the DRX at the UE and that a fourth downlink BWP of the second plurality of downlink BWPs is associated with transmission of the wake-up signal to trigger the active time associated with the DRX at the UE.

Aspect 26: The method of aspect 25, wherein the second information indicates that the third downlink BWP is configured with a search space set associated with the DCI message and that the fourth downlink BWP is configured with one or more monitoring occasions associated with the wake-up signal.

Aspect 27: The method of any of aspects 25-26, wherein the second information indicates that the second serving cell is configured with one or more monitoring occasions associated with the wake-up signal; that the third downlink BWP is configured with a search space set associated with the DCI message; and that the fourth downlink BWP is absent of a search space set configuration associated with the DCI message.

Aspect 28: The method of any of aspects 25-27, further comprising: transmitting, via the second serving cell, the DCI message or the wake-up signal in accordance with one or both of which of the third downlink BWP or the fourth downlink BWP is an active downlink BWP of the second serving cell or a rule associated with monitoring for DCI messages to trigger the active time and monitoring for wake-up signals to trigger the active time via different serving cells of different groups of cells.

Aspect 29: The method of aspect 28, wherein the rule indicates that the network entity is able to transmit DCI messages to trigger the active time and is able to transmit wake-up signals to trigger the active time simultaneously via the different serving cells of the different groups of cells.

Aspect 30: The method of aspect 28, wherein the rule indicates that the network entity is to transmit one of DCI messages or wake-up signals to trigger the active time across the different serving cells of the different groups of cells.

Aspect 31: The method of any of aspects 28-30, wherein the different groups of cells are associated with an MCG and an SCG; a primary PUCCH group and a secondary PUCCH group; or a first DRX group and a second DRX group.

Aspect 32: The method of any of aspects 18-31, further comprising: transmitting a message that indicates that one of the first downlink BWP or the second downlink BWP is the active downlink BWP of the first serving cell.

Aspect 33: The method of any of aspects 18-32, further comprising: transmitting control signaling associated with a configuration of the DRX at the UE, wherein the configuration of the DRX is associated with at least the first serving cell.

Aspect 34: The method of any of aspects 18-33, wherein the DCI message is associated with a DCI format 2_6; the wake-up signal is associated with an LP-WUS waveform; and the active time associated with the DRX at the UE corresponds to a time window defined at least by a DRX on duration timer.

Aspect 35: A UE for wireless communication, comprising one or more memories storing processor-executable code, and one or more processors coupled with the one or more memories and individually or collectively operable to execute the code to cause the UE to perform a method of any of aspects 1-17.

Aspect 36: A UE for wireless communication, comprising at least one means for performing a method of any of aspects 1-17.

Aspect 37: A non-transitory computer-readable medium storing code for wireless communication, the code comprising instructions executable by one or more processors to perform a method of any of aspects 1-17.

Aspect 38: A network entity for wireless communication, comprising one or more memories storing processor-executable code, and one or more processors coupled with the one or more memories and individually or collectively operable to execute the code to cause the network entity to perform a method of any of aspects 18-34.

Aspect 39: A network entity for wireless communication, comprising at least one means for performing a method of any of aspects 18-34.

Aspect 40: A non-transitory computer-readable medium storing code for wireless communication, the code comprising instructions executable by one or more processors to perform a method of any of aspects 18-34.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a GPU, an NPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers.

Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive first information pertaining to a first plurality of downlink bandwidth parts associated with a first serving cell, wherein the first information indicates that:
a first downlink bandwidth part of the first plurality of downlink bandwidth parts is associated with monitoring for a downlink control information message to trigger an active time associated with discontinuous reception at the UE, and
a second downlink bandwidth part of the first plurality of downlink bandwidth parts is associated with monitoring for a wake-up signal to trigger the active time associated with the discontinuous reception at the UE; and
monitor for the downlink control information message or the wake-up signal in accordance with the first information and in accordance with which of the first downlink bandwidth part or the second downlink bandwidth part is an active downlink bandwidth part of the first serving cell.

2. The UE of claim 1, wherein, to monitor for the downlink control information message or the wake-up signal, the one or more processors are individually or collectively operable to execute the code to cause the UE to:
monitor for the downlink control information message to trigger the active time in accordance with the first downlink bandwidth part being the active downlink bandwidth part of the first serving cell; or
monitor for the wake-up signal to trigger the active time in accordance with the second downlink bandwidth part being the active downlink bandwidth part of the first serving cell.

3. The UE of claim 1, wherein the first information indicates that:
the first downlink bandwidth part is configured with a search space set associated with the downlink control information message; and
the second downlink bandwidth part is configured with one or more monitoring occasions associated with the wake-up signal.

4. The UE of claim 3, wherein:
the first downlink bandwidth part is associated with monitoring for the downlink control information message to trigger the active time in accordance with being configured with the search space set associated with the downlink control information message; and
the second downlink bandwidth part is associated with monitoring for the wake-up signal to trigger the active time in accordance with being configured with the one or more monitoring occasions associated with the wake-up signal.

5. The UE of claim 3, wherein the first information indicates that:
the first downlink bandwidth part is additionally configured with one or more second monitoring occasions associated with the wake-up signal, the first information further indicating that, of the downlink control information message and the wake-up signal, the first downlink bandwidth part is to be associated with monitoring for the downlink control information message to trigger the active time; or
the second downlink bandwidth part is additionally configured with a second search space set associated with the downlink control information message, the first information further indicating that, of the downlink control information message and the wake-up signal, the second downlink bandwidth part is to be associated with monitoring for the wake-up signal to trigger the active time.

6. The UE of claim 1, wherein the first information indicates that:
the first serving cell is configured with one or more monitoring occasions associated with the wake-up signal;
the first downlink bandwidth part is configured with a search space set associated with the downlink control information message; and
the second downlink bandwidth part is absent of a search space set configuration associated with the downlink control information message.

7. The UE of claim 6, wherein:
the first downlink bandwidth part is associated with monitoring for the downlink control information message to trigger the active time in accordance with being configured with the search space set associated with the downlink control information message; and
the second downlink bandwidth part is associated with monitoring for the wake-up signal to trigger the active time in accordance with being absent of the search space set configuration associated with the downlink control information message and in accordance with the first serving cell being configured with the one or more monitoring occasions associated with the wake-up signal.

8. The UE of claim 1, wherein the one or more processors are individually or collectively further operable to execute the code to cause the UE to:
receive second information pertaining to a second plurality of downlink bandwidth parts associated with a second serving cell, wherein the second serving cell is associated with a different group of cells than the first serving cell, and wherein the second information indicates that:
a third downlink bandwidth part of the second plurality of downlink bandwidth parts is associated with monitoring for the downlink control information message to trigger the active time associated with the discontinuous reception at the UE, and
a fourth downlink bandwidth part of the second plurality of downlink bandwidth parts is associated with monitoring for the wake-up signal to trigger the active time associated with the discontinuous reception at the UE.

9. The UE of claim 8, wherein the second information indicates that the third downlink bandwidth part is configured with a search space set associated with the downlink control information message and that the fourth downlink bandwidth part is configured with one or more monitoring occasions associated with the wake-up signal.

10. The UE of claim 8, wherein the second information indicates that the second serving cell is configured with one or more monitoring occasions associated with the wake-up signal; that the third downlink bandwidth part is configured with a search space set associated with the downlink control information message; and that the fourth downlink bandwidth part is absent of a search space set configuration associated with the downlink control information message.

11. The UE of claim 8, wherein the one or more processors are individually or collectively further operable to execute the code to cause the UE to:
monitor the second serving cell for the downlink control information message or the wake-up signal in accordance with one or both of:
which of the third downlink bandwidth part or the fourth downlink bandwidth part is an active downlink bandwidth part of the second serving cell; or
a rule associated with monitoring for downlink control information messages to trigger the active time and monitoring for wake-up signals to trigger the active time via different serving cells of different groups of cells.

12. The UE of claim 11, wherein the rule indicates that the UE is able to monitor for downlink control information messages to trigger the active time and is able to monitor for wake-up signals to trigger the active time simultaneously via the different serving cells of the different groups of cells.

13. The UE of claim 11, wherein the rule indicates that the UE is to monitor for one of downlink control information messages or wake-up signals to trigger the active time across the different serving cells of the different groups of cells.

14. The UE of claim 11, wherein the different groups of cells are associated with:
a master cell group and a secondary cell group;
a primary physical uplink control channel group and a secondary physical uplink control channel group; or
a first discontinuous reception group and a second discontinuous reception group.

15. A method for wireless communication at a user equipment (UE), comprising:
receiving first information pertaining to a first plurality of downlink bandwidth parts associated with a first serving cell, wherein the first information indicates that:
a first downlink bandwidth part of the first plurality of downlink bandwidth parts is associated with monitoring for a downlink control information message to trigger an active time associated with discontinuous reception at the UE, and
a second downlink bandwidth part of the first plurality of downlink bandwidth parts is associated with monitoring for a wake-up signal to trigger the active time associated with the discontinuous reception at the UE; and
monitoring for the downlink control information message or the wake-up signal in accordance with the first information and in accordance with which of the first downlink bandwidth part or the second downlink bandwidth part is an active downlink bandwidth part of the first serving cell.

16. The method of claim 15, wherein monitoring for the downlink control information message or the wake-up signal comprises:
monitoring for the downlink control information message to trigger the active time in accordance with the first downlink bandwidth part being the active downlink bandwidth part of the first serving cell; or
monitoring for the wake-up signal to trigger the active time in accordance with the second downlink bandwidth part being the active downlink bandwidth part of the first serving cell.

17. The method of claim 15, further comprising:
receiving a message that indicates that one of the first downlink bandwidth part or the second downlink bandwidth part is the active downlink bandwidth part of the first serving cell.

18. The method of claim 15, further comprising:
receiving control signaling associated with a configuration of the discontinuous reception at the UE, wherein the configuration of the discontinuous reception is associated with at least the first serving cell.

19. The method of claim 15, wherein:
the downlink control information message is associated with a downlink control information format 2_6;
the wake-up signal is associated with a low-power wake-up signal waveform; and
the active time associated with the discontinuous reception at the UE corresponds to a time window defined at least by a discontinuous reception on duration timer.

20. A user equipment (UE) for wireless communication, comprising:
means for receiving first information pertaining to a first plurality of downlink bandwidth parts associated with a first serving cell, wherein the first information indicates that:
a first downlink bandwidth part of the first plurality of downlink bandwidth parts is associated with monitoring for a downlink control information message to trigger an active time associated with discontinuous reception at the UE, and
a second downlink bandwidth part of the first plurality of downlink bandwidth parts is associated with monitoring for a wake-up signal to trigger the active time associated with the discontinuous reception at the UE; and
means for monitoring for the downlink control information message or the wake-up signal in accordance with the first information and in accordance with which of the first downlink bandwidth part or the second downlink bandwidth part is an active downlink bandwidth part of the first serving cell.
